(19) United States
(12) Patent Application Publication
(10) Pub. No.: US 2020/0219074 A1
(43) Pub. Date: Jul. 9, 2020

(54) TRANSACTION PAYMENT PROCESSING SYSTEM IMPLEMENTING A VIRTUAL EXCHANGE PLATFORM ON WHICH NON-AFFILIATED BUSINESSES PROVIDE TRANSFERABLE CUSTOMER REWARDS

(71) Applicant: Citifyd, Inc., Portland, OR (US)

(72) Inventor: Sohrab Vossoughi, Portland, OR (US)

(21) Appl. No.: 16/738,881

(22) Filed: Jan. 9, 2020

Related U.S. Application Data
(60) Provisional application No. 62/790,395, filed on Jan. 9, 2019.

(51) Int. Cl. G06Q 20/14; G06Q 20/02; G06Q 20/32; G06Q 30/02; G07F 17/24

(52) U.S. Cl. CPC G06Q 20/14; G06Q 20/02; G06Q 20/325; G07F 17/24; G06Q 20/3276; G06Q 30/0208; G06Q 20/3274

(57) ABSTRACT

A transaction payment processing system includes a backend transaction system that performs credit and debit processes for multiple user accounts, merchant accounts, and service provider accounts. The backend transaction system is preferably part of backend servers. The transaction payment processing system preferably uses wireless technologies to carry out a method of debiting and crediting multiple ones of each of the user, merchant, and parking service accounts with incremental amounts of money over a set period of time. The transaction payment processing system enables practice of a virtual exchange method of processing transfers of member transaction credits such as, for example, points or monetary units among account holder members of a community of businesses that are allied in support of one another. Transfers of member transaction credits among account holder members stimulates commercial activity by supporting sale of goods and services offered by the members of the community of businesses.

### RELATED APPLICATION

This application claims benefit of U.S. Patent Application No. 62/790,395, filed Jan. 9, 2019, and incorporated herein by reference in its entirety.

### COPYRIGHT NOTICE

© 2020 Citifyd, Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(d).

### TECHNICAL FIELD

This disclosure relates to vehicle parking payment processing and, in particular, to a dynamic vehicle parking management platform that is based on existing infrastructure and vehicle driver behavior to simplify parking fee payment transactions. The disclosed parking management platform implements wireless communication technologies to free vehicle drivers from inconveniences of manual parking fee payment while creating business and marketing opportunities for local merchants to develop as customers vehicle drivers parking their vehicles in areas nearby the merchants' stores.

### BACKGROUND INFORMATION

Millions of drivers park their vehicles daily on city streets, in parking lots, or in garage facilities. Municipalities for many years have been collecting and typically still collect parking fees from vehicle drivers making payments through use of mechanical or electronic parking meters. Municipalities use parking fee revenues to enforce integrated on street parking policy, usually related to traffic and mobility management policies. Since its first deployment in 1936, the mechanical parking meter has undergone many innovations and improvements. All such devices are, however, costly for municipalities to install and operate and are either difficult or inconvenient for the vehicle drivers to use. Private providers of surface parking lot and parking garage facilities are staffed by either an on-site attendant to process parking permit tickets and collect parking fees or roving parking control attendants to ensure parking fee payment compliance. The manual collection of parking permit tickets and fee payments is labor intensive and costly to private parking providers.

What is needed is a dynamic parking management platform that implements a parking fee payment and collection system that simplifies the process of fee-based parking by vehicle drivers and the duties of parking control personnel, as well as reduces the cost of operation and management of (1) metered and non-metered on-street parking to municipalities and (2) parking lots and garage facilities to private providers.

### SUMMARY OF THE DISCLOSURE

The disclosed dynamic parking management platform is implemented in hardware and software and is based on the existing infrastructure and behavior of the users (vehicle drivers) and parking service providers (municipalities and their parking enforcement officers; private providers and their parking facility attendants; private individuals). (The terms “user” and “vehicle driver” are used interchangeably throughout the descriptions presented herein.) The disclosed system enables dynamic pricing of parking fees and dynamic setting of parking time limits, and thereby implementation of different revenue models, and paperless issuance of different types of parking permits by the municipalities or private providers.

Main components of the parking management platform include a mobile communication device (e.g., smartphone) App of a parking service provider (e.g., municipality or private parking provider), a parking (i.e., backend) server on which the parking service provider stores parking account and transaction information, and an auxiliary electronic ticket or “E-Ticket” device. The user creates an account that resides on the parking server by downloading the App to the user's mobile communication device and carrying out the account formation process. Thereafter, the user receives, in the mail from, or at a conveniently located authorized source, an E-Ticket device in the form of a credit card size display or radio signal beacon-emitting capable device. The user performing procedural steps presented by the interface of the App operating on the user's mobile communication device can set up a parking payment account with the parking service provider, provide credit (or debit) card information, and check at any time a statement of parking activities. Setting up a parking payment account is a one-time operation, which takes place during an initial use of the App. The parking server credits the accounts of all parking service providers who have subscribed to parking server operator services. The vehicle driver uses the App to communicate with and actuate the E-Ticket device and the parking account established with and residing on the parking server to effect a parking fee payment transaction between the vehicle driver's credit card and the parking account.

In all cases of parking provider services, the App informs the vehicle driver about locations of different time-limited parking zones; locations of parking garages, parking lots, street parking areas, and privately owned parking areas (e.g., a homeowner's driveway); different garage facility, parking lot, and street parking rates before parking; and the amount of time remaining before expiration of parking time allowed under a time limit. The App also informs the vehicle driver about the location of the vehicle after parking; the amount of elapsed parking time; and, with a predetermined amount of parking time remaining (e.g., 10 minutes), the amount of walking time needed to return to the parked vehicle. The App can cause the E-Ticket device or the mobile communication device itself to emit a beacon that causes a parking garage barrier gate to open at the start of a parking session. The App also uses encryption technology to transfer data, activate and deactivate the E-Ticket device, and communicate to the parking server the amount of time the vehicle occupied the parking space.

The parking management platform implements a lock and key feature that affords a highly secure parking transaction. Secure parking transactions are achieved by the use of two separate devices, the E-Ticket device and the mobile communication device, operating in proximity to each other. When they are in proximity to each other, these two devices communicate over a short-range wireless communication link and exchange identification information to achieve secure device pairing that enables connection to the parking servers. Forming a connection with the parking servers enables a vehicle driver to carry out a parking related transaction. No parking related transaction can be performed when the E-Ticket and mobile communication devices are separated from each other by a distance that is outside the connectivity range of the short-range wireless communication link. A lost or stolen E-Ticket device or mobile communication device cannot, therefore, itself be used to perform a parking related transaction because no connection to the parking servers can be achieved.

The parking management platform makes possible a service that frees a vehicle driver from all hassles and inconveniences of paying for on-street, surface lot, or garage facility parking. The parking fee payment service enabled by this parking management platform is implemented without (1) changes to the street parking infrastructure of and management process practiced by a municipality or (2) disruptive changes to private parking lot or garage facility operations. The disclosed parking management platform is configured such that municipalities could eventually eliminate most, if not all, of their parking meter machines.

The transaction payment processing system disclosed enables practice of a virtual exchange method of processing transfers of member transaction credits among multiple account holder members of a community of businesses that are allied in support of one another. The member transaction credits are in the form of, for example, business community points or monetary units. The virtual exchange method entails exchanges of the member transaction credits among the member businesses to stimulate commercial activity within the community of businesses. The member transaction credits are characterized in that a member transaction credit held in a seller member's account need not be used exclusively to transact a sale of the seller member's goods or services to a buyer member. The method is carried out with use of a virtual exchange platform server of a transaction processing system in which each of the multiple account holder members has a member account and communicates with the platform server over a wireless communication link between the platform server and a mobile communication device on which a virtual exchange App operates. The virtual exchange App presents on the mobile communication device the identities of the multiple account holder members, and the platform server operates to process debit and credit transactions of member transaction credits among the multiple account holder members that exchanged member transaction credits in connection with products or services provided.

The method comprises storing, for access by the platform server, information relating to values of member transaction credits attributed to each one of the member accounts. Information relating to member transaction credits that are attributed to each one of the member accounts as exchanges resulting from selling of goods or services and that are redeemed by corresponding ones of the member accounts as exchanges resulting from buying of goods or services is collected for use in operation of the platform server. The redemption of member transaction credits results from a payment command generated in response to assertion of a control actuator produced by the virtual exchange App operating on a mobile communication device associated with a buyer member of the account holder members and from recognition of the payment command received by the virtual exchange App operating on a mobile communication device associated with a seller member of the account holder members. These acts complete a transfer of member transaction credits by redemption of the member transaction credits to the member account of the buyer member and credit of the member transaction credits to the member account of the seller member. For each member account, the member transaction credits redeemed by buying of goods or services from the corresponding ones of the member accounts are consolidated as community member debits. For each member account, the member transaction credits received by selling of goods or services to the corresponding ones of the member accounts are consolidated as community member credits. A final account member holder debit amount representing the consolidation of member transaction credits redeemed by the member account is applied to each member account. A final account member holder credit amount representing the consolidation of member transaction credits credited to the member account is applied to each member account to make a record of available member transaction credits to each account holder member for use in stimulating commercial activity by supporting sale of goods and services offered by the multiple account holder members of the community of businesses.

Additional aspects and advantages will be apparent from the following detailed description of preferred embodiments, which proceeds with reference to the accompanying drawings.

### BRIEF DESCRIPTION OF THE DRAWINGS

FIG. 1 is a system block diagram showing the main components of a parking fee payment and collection management system representing a preferred embodiment of the disclosed parking management platform.

FIG. 2 is a block diagram of an auxiliary E-Ticket device shown in the system of FIG. 1.

FIGS. 3-1-3-8 illustrate the communication signal connections among the components of the system of FIG. 1 as a vehicle driver performs the various parking transaction account-related acts.

FIGS. 4A and 4B are respective front and rear perspective views of the E-Ticket device shown in FIG. 2.

FIGS. 5A, 5B, and 5C are, respectively, front, rear, and side elevation views of the E-Ticket device of FIGS. 4A and 4B.

FIG. 6 is a diagram of a payment processing transaction system for implementing a virtual exchange platform that processes debit and credit transactions among multiple entities.

FIG. 7, includes a first set of four drawing sheets (FIGS. 7-1, 7-2, 7-3, and 7-4) that constitute a flow diagram showing the functions performed by the payment processing transaction system of FIG. 6 and a second set of three drawing sheets (FIGS. 7-5, 7-6, and 7-7) that show three flow diagrams representing common, lower transaction cost, and lower transaction cost and fee multi-transaction payment processes.

FIG. 8 is a block diagram showing an alternative embodiment of the wireless transaction system of FIG. 6.

FIGS. 9 and 10 are perspective views of, respectively, the top and bottom of a validation beacon device embodied as a self-contained electronic display module.

FIG. 11 is a plan view of a validation beacon device embodied as a small, thin profile self-contained beacon unit having a housing to which is attached a set of substrates on which barcodes or QR codes are printed.

FIG. 12 is a plan view of a validation beam device of the type shown in FIG. 11, with the exception that the set of substrates is physically separate from the housing.

FIG. 13 is a simplified diagram showing the correlation between user and merchant accounts in securely carrying out a merchant credit offer authorization and validation process.

FIGS. 14, 15, and 16 show the interaction and connectivity paths configured to achieve secure code validation in the use of the validation beacon devices shown in FIGS. 9 and 10, FIG. 11, and FIG. 12, respectively.

FIG. 17 includes a set of three drawing sheets (FIGS. 17-1, 17-2, and 17-3), that constitute a flow diagram showing the functions performed by the transaction payment processing system of FIG. 6 in carrying out the virtual exchange method for business rewards.

FIG. 18, which includes a set of five drawing sheets (FIGS. 18-1, 18-2, 18-3, 18-4, and 18-5), is a flow diagram of screenshots showing information displayed on a mobile communication device in correspondence to the functions performed as described with reference to FIG. 17.

### DETAILED DESCRIPTION OF PREFERRED EMBODIMENTS

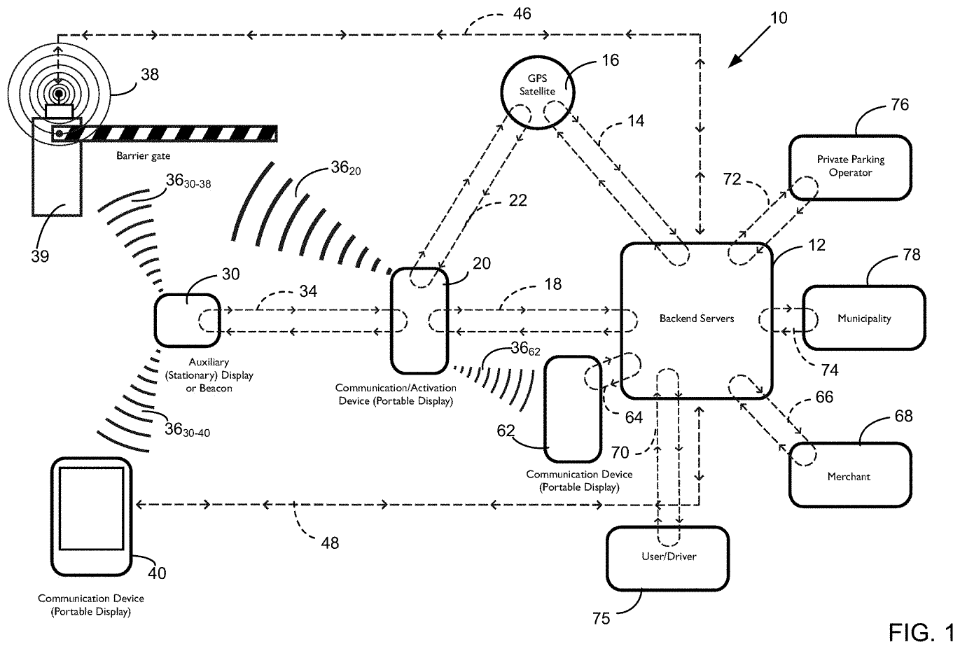

FIG. 1 is a system block diagram showing the main components of a parking fee payment and collection management system 10, as a preferred embodiment of the disclosed parking management platform. With reference to FIG. 1, system 10 includes one or more backend or parking servers 12 on which a parking service provider stores parking account information and transaction information. A preferred parking service provider is a municipality or a private parking provider that uses parking servers 12 to process transactions associated with established vehicle driver parking fee payment accounts. (A parking service provider could, of course, enter into a contractual arrangement with a separate entity to process transactions associated with the parking fee payment accounts.) Parking servers 12 are implemented with a communication signal interface to establish a wireless radio signal communication link 14 with a navigation system 16, such as the global positioning system (GPS) space-based satellite network, and a wireless communication link 18 through cellular communication network protocols with a wireless-connection enabled mobile communication device 20, such as a smartphone carried by a vehicle driver. Mobile communication device 20 is implemented with a communication signal interface to establish communication link 18 and establish a wireless radio signal communication link 22 with GPS navigation system 16. Communication links 14 and 22 established with GPS navigation system 16 are used to determine, and provide to parking servers 12, information about the location and movement of the vehicle driver carrying mobile communication device 20.

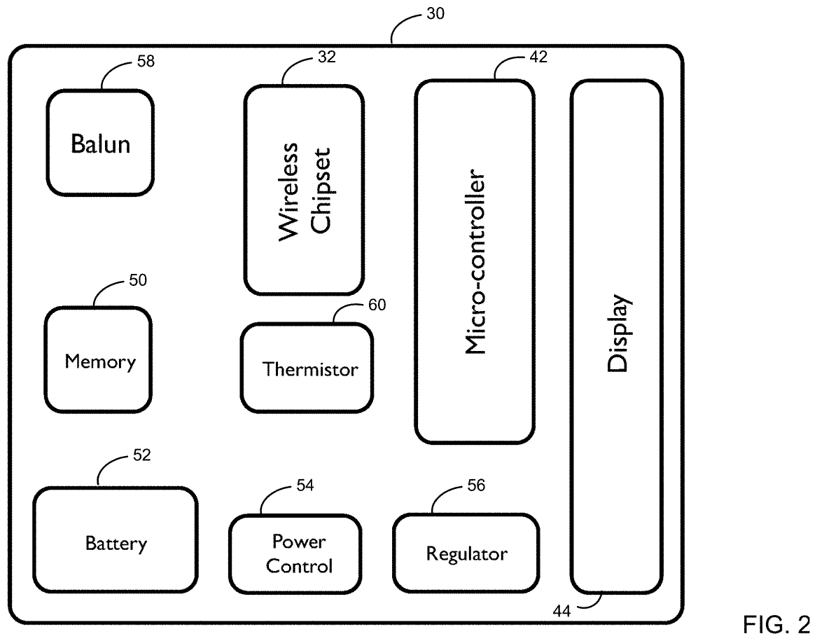

System 10 also includes an auxiliary E-Ticket device 30, a block diagram of which is shown in greater detail in FIG. 2. With reference to FIGS. 1 and 2, E-Ticket device 30 is implemented with a wireless connection protocol device or communication signal interface 32 that produces a short-range wireless radio signal (e.g., Bluetooth®, ZigBee®, or Near Field Communication (NFC) wireless communication technologies). The radio signal produced by communication signal interface 32 is used to establish one or both of (1) a wireless communication link 34 between E-Ticket device 30 and mobile communication device 20 and (2) a wireless communication link 36₃₀₋₃₈ by emission of a beacon signal to a parking lot or garage barrier gate transceiver 38 mounted on a barrier gate bollard 39 or a wireless communication link 36₃₀₋₄₀ by emission of a beacon signal to a portable display-equipped communication device 40 carried by a parking patrol officer or parking service attendant. (A parking service attendant would include a private property owner managing a private parking service for use of, for example, the driveway of the property owner's home.) E-Ticket device 30, which has a thin profile and is about the size of a credit card, is a display device that includes a microcontroller 42 performing, among other operations, clock and timer functions.

A communication link 36₃₀₋₃₈ between E-Ticket device 30 and barrier gate transceiver 38 may also be established by emission of a beacon signal from transceiver 38. This beacon signal is preferably implemented in the ZigBee® communication protocol because it exhibits higher security and lower power consumption as compared with the security level and power consumption of other currently available wireless personal area networks.

For implementations in which a beacon signal is not in use, E-Ticket device 30, by way of communication link 34, receives from mobile communication device 20 a start timer command to track vehicle parking time, information about maximum allocated parking time, and current parking time information for presentation on a display surface 44. When in use in a parked vehicle, E-Ticket device 30 remains stationary after its placement inside the parked vehicle and at a location (e.g., rests on the vehicle dashboard or against the vehicle window) in plain view of a parking patrol officer or parking service attendant tasked with reading parking time information presented on display surface 44. An option would be to integrate the functionality of E-Ticket device 30 by installing it into a vehicle dashboard instrument console, at a location where display surface 44 would be visible from outside the vehicle. Parking time information includes parking time remaining before expiration of the vehicle parking time allowed under the time limit specified for the parking area or any grace period provided after expiration of the vehicle parking time.

For implementations in which a beacon signal is in use, either E-Ticket 30 emits beacon signal for reception by barrier gate transceiver 38 or barrier gate transceiver 38 emits a beacon signal for reception by E-Ticket 30 to initiate the process of opening a parking entrance gate as a vehicle enters a gated parking lot or garage. The App operating on mobile communication device 20 could also cause emission of a beacon signal for acquisition by barrier gate transceiver 38 or enable reception of a beacon signal emitted by barrier gate transceiver 38 to establish a communication link 36₂₀ to initiate the process of opening the parking entrance gate. Mobile communication device 20 cannot, however, establish communication link 36₂₀ in the absence of connectivity with E-Ticket device 30. Unless they are in proximity to each other within the connectivity range of the wireless connection, E-Ticket device 30 and mobile communication device 20 cannot achieve a device pairing connection and, therefore, cannot produce signals that cooperate to initiate a parking transaction. This ensures, for example, that the barrier gate cannot be opened as a person carrying mobile communication device 20, and while leaving a parking lot or garage and leaving behind E-ticket device 30 in the parked vehicle, walks by barrier gate transceiver 38.

Each of the beacon signals emitted, or produced in response to beacon signals emitted by barrier gate transceiver 38, by E-Ticket 30 to establish communication link 36₃₀₋₃₈ and mobile communication device 20 to establish communication link 36₂₀ carries an identification number associated with the vehicle driver's parking account. The identification number is transmitted by way of wireless communication link 46 to parking servers 12 to verify the parking account, obtain all pertinent information, open the account, and start a timer to count the amount of parking time used. E-Ticket device 30 also counts the amount of elapsed parking time and presents it for observation on display surface 44. Parking servers 12 transmit through communication link 46 a gate opening signal to barrier gate transceiver 38, upon verification of the parking account, and parking fee information to mobile communication device 20.

E-Ticket 30 emits a beacon signal that is transmitted over communication link 36₃₀₋₄₀ for reception also by communication device 40 to display to a parking patrol officer or parking service attendant the vehicle driver's account identification number and to transmit the vehicle driver's account identification number by a wireless radio communication link 48 to parking servers 12. Each of wireless communication links 46 and 48 communicates preferably, but not necessarily, through Internet Protocol (IP) technology. The beacon signal emission capability enables a parking patrol officer parking service attendant to obtain information about the vehicle parking time without having to view display surface 44 on E-Ticket 30. Using beacon signal emissions can eliminate a need for and cost of display surface 44 on E-Ticket 30. E-Ticket device 30 constructed without display surface 44 would be preferably equipped with light-emitting diodes (LEDs) functioning as indicators of operational status, parking time expiration, grace period operation, or other such status conditions.

The vehicle driver returning to the parking area uses the App operating on mobile communication device 20 to send to E-ticket device 30 a stop timer command and to signal parking servers 12 to stop the timer and obtain the total parking time. Parking servers 12 thereafter conclude the transaction by closing the parking account and applying the parking fee charge to the vehicle driver's credit card on file.

Microcontroller 42 coordinates the communication of information delivered to and received from mobile communication device 20, manages storage of information in memory sites 50, and processes information for display on display surface 44. E-Ticket device 30 has its own electrical power supply, including a battery 52, power control circuitry 54, and a voltage regulator 56. Communication signal interface 32 is preferably a ZigBee® wireless chipset, and a balun 58 provides an impedance match for the antenna in the module containing wireless chipset 32. A thermistor 60 monitors the ambient temperature of E-Ticket device 30 and enables microcontroller 42 to deactivate E-Ticket device 30 when it is exposed to extreme temperatures.

FIG. 1 also shows components of system 10 that implement authorization and redemption processes carried out when the vehicle driver interacts with a parking attendant or a merchant. Mobile communication device 20 transmits a short-range wireless radio signal carrying an authorization or a redemption code for receipt by an attendant/merchant communication device 62. The signal carrying the authorization or redemption code establishes a wireless communication link 36₆₂ with attendant/merchant communication device 62 when it is located in proximity to mobile communication device 20. In response to the signal, attendant/merchant communication device 62 produces a radio signal that establishes a wireless communication link 64 with parking servers 12 to obtain information indicating whether to authorize entry into a parking facility or to authorize a transaction and an associated redemption code.

The following describes in detail the operation of system 10 when a vehicle driver undertakes to establish a parking transaction account on system 10, use system 10 to locate and pay for use of a parking area, and check parking activity on the parking transaction account record. FIGS. 3-1-3-8 illustrate the communication signal connections among the components of system 10 as the vehicle driver performs the various parking transaction account-related acts stated above.

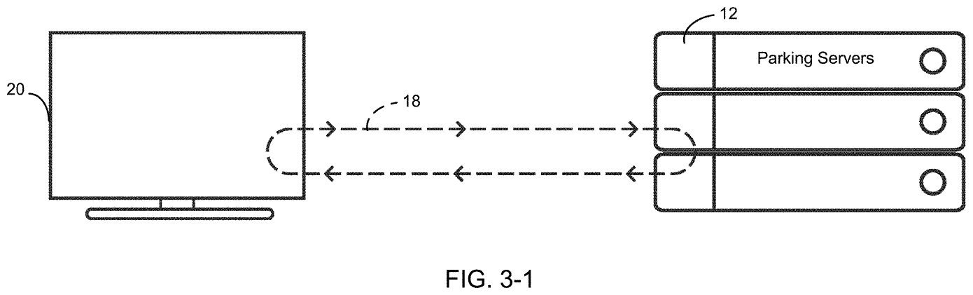

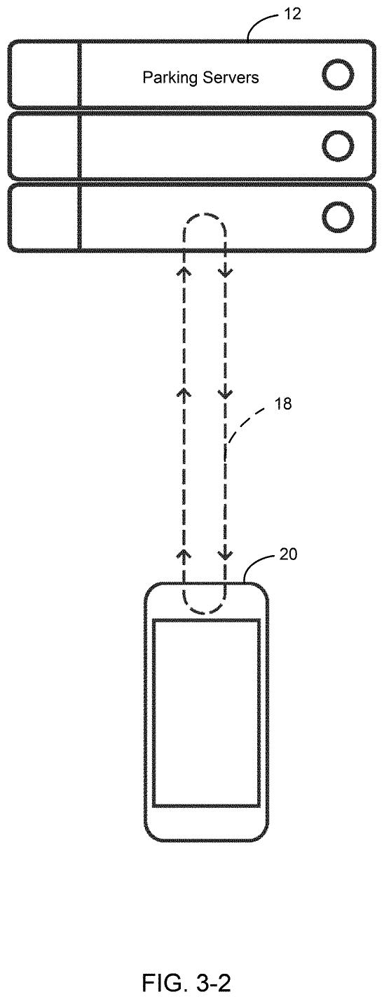

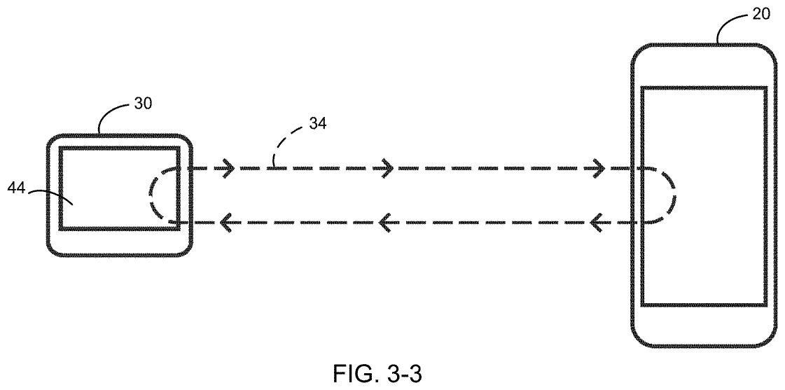

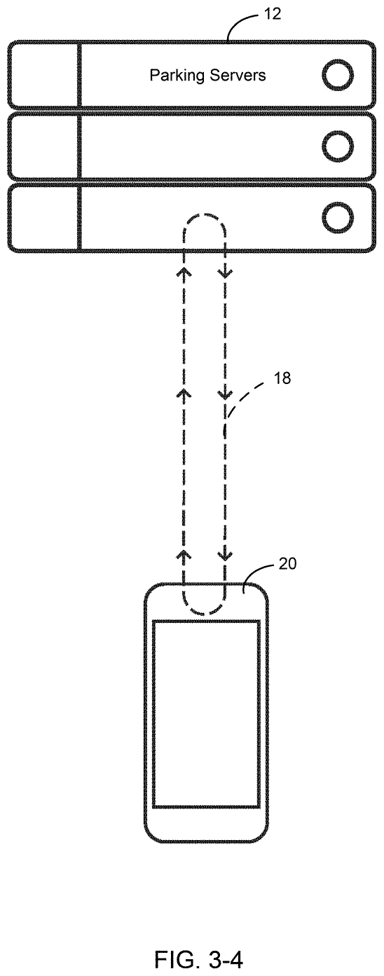

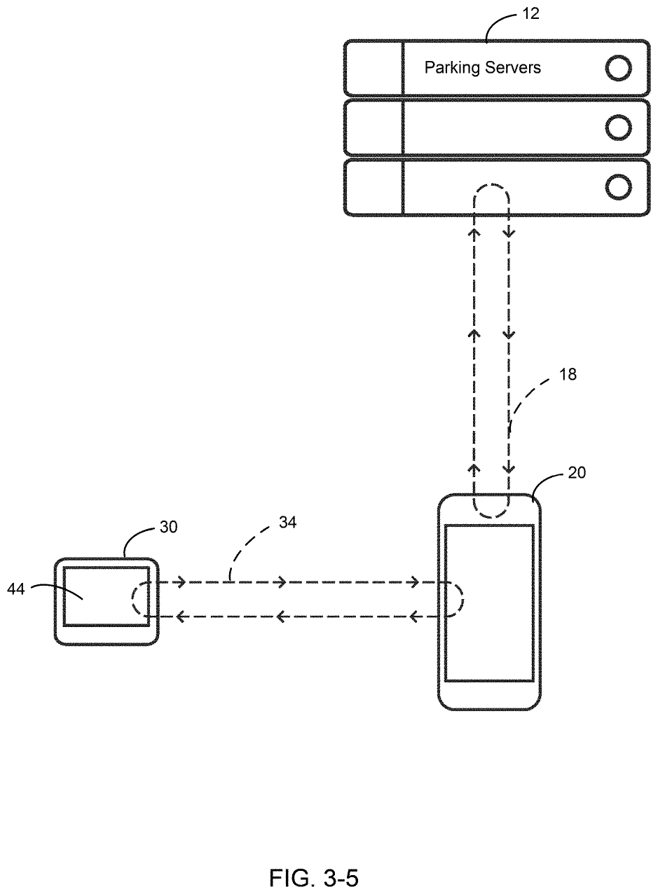

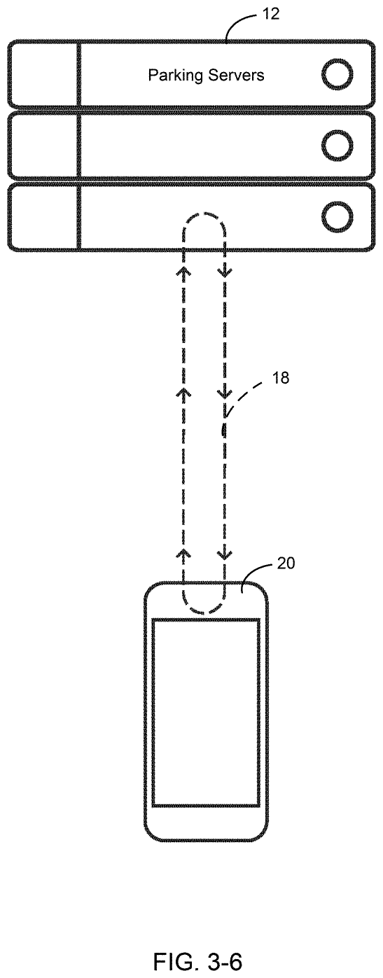

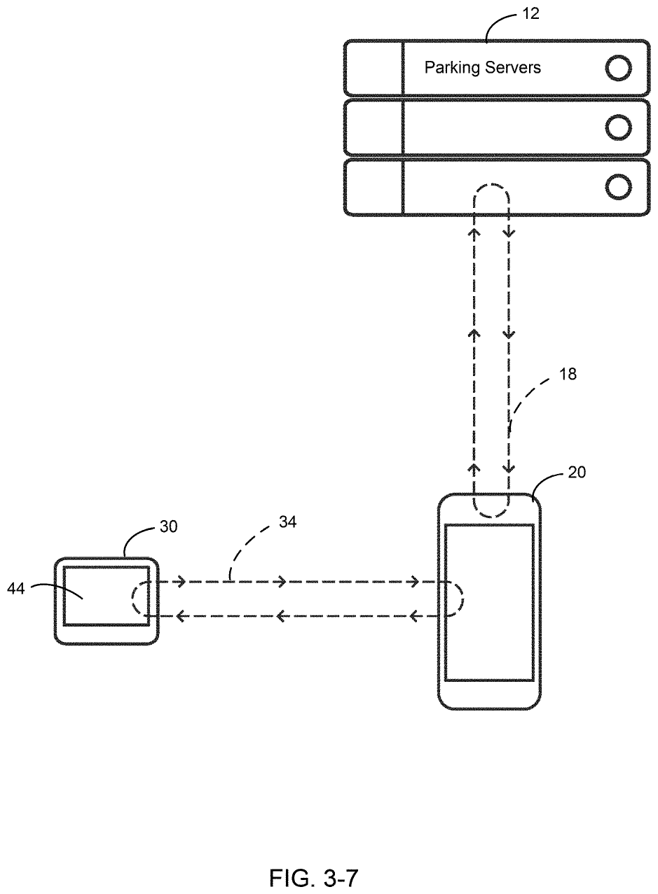

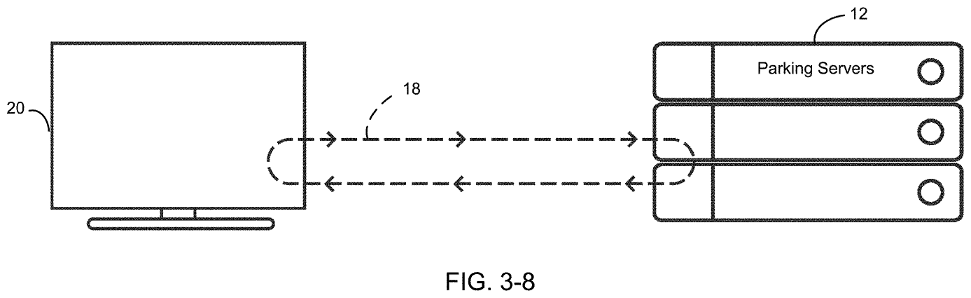

With reference to FIG. 3-1, using mobile communication device 20 communicating through a wireless communication link 18, a vehicle driver sets up on parking servers 12 a parking payment account for the parking service provider. The parking payment account includes password, mobile telephone, and credit card numbers, as well as other account set-up information such as the vehicle license plate identification information. The vehicle driver can customize the user interface (e.g., font size), time intervals for alerts, and other user-preferred feature settings. A unique, coded mobile communication device App is generated and assigned to the parking transaction account, which is set up to recognize the vehicle driver's mobile telephone number. (The vehicle driver could alternatively use a personal computer communicating through a wireless Internet Protocol connection to set up the parking payment account. This less desirable approach would entail construction of a website interface at extra cost.)

With reference to FIG. 3-2, the vehicle driver downloads the App to mobile communication device 20. The App recognizes the mobile telephone number and is then uploaded to mobile communication device 20.

With reference to FIG. 3-3, using the downloaded App operating on mobile communication device 20, the vehicle driver enters the serial number of E-Ticket device 30. The vehicle driver synchronizes the App with E-Ticket device 30 through Bluetooth® or NFC communication link 34. A lock and key combination is created between the App, which is dedicated to the vehicle driver's specified mobile (i.e., cellular) telephone number, and E-Ticket device 30. The completion of this procedure establishes the parking payment account. The lock and key combination established between E-Ticket device 30 and mobile communication device 20 with use of the specified cellular telephone number implements a secure device pairing that prevents unauthorized parking charges against the vehicle driver's parking account. E-Ticket device 30 itself is incapable of communicating with parking servers 12; therefore, theft or loss of E-Ticket device 30 cannot compromise the vehicle driver's parking account. Mobile communication device 20 carried by any individual located outside the connectivity distance range of communication link 34 cannot interact with E-Ticket device 30 and cannot initiate account activity with parking servers 12. A lost mobile communication device 20 cannot, therefore, be used to activate an account or accumulate parking charges on the vehicle driver's parking account.

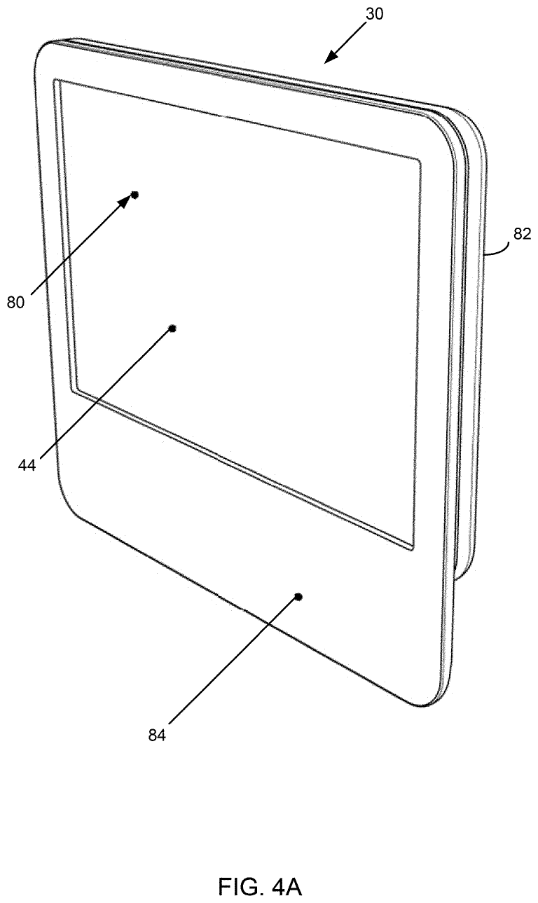

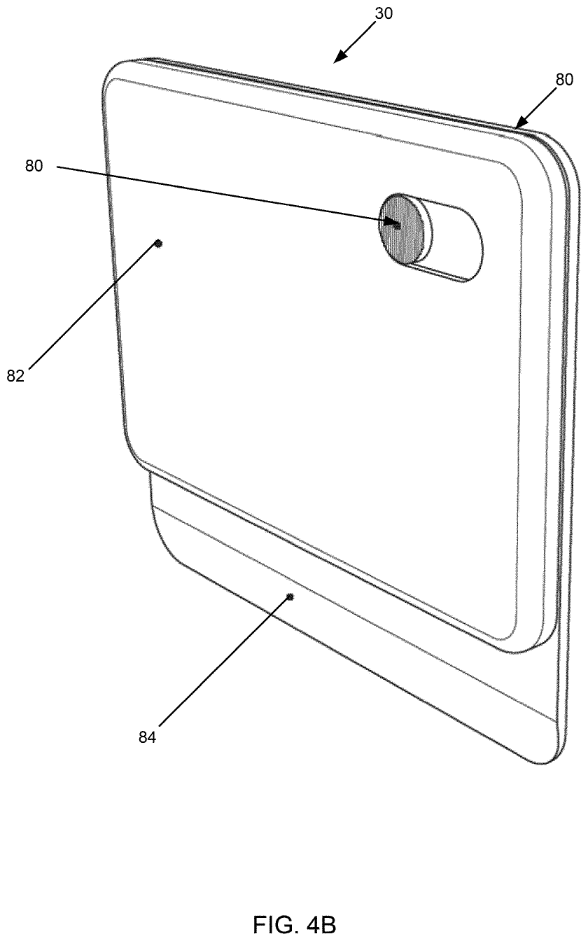

With reference to FIG. 3-4, the driver parking the vehicle launches the App stored on mobile communication device 20 and identifies the destination location.

With reference to FIG. 3-5, using the App, the vehicle driver filters one or both of the parking time charge rate and the length of parking time needed. The App shows the parking time charge rates and the locations where the vehicle driver can find parking areas allowing the desired length of parking time around the driver's destination. The vehicle driver finds a suitable parking area and visually checks or uses the GPS capability of the App to recognize the parking time limitation specified for the parking area. Operating with Google Maps for Mobile location service and responding to radio signals propagating through communication link 22, the App recognizes the location of mobile communication device 20 to 3 m-8 m accuracy. The recognized location of mobile communication device 20 carried by the vehicle driver indicates the location of the vehicle and enables provision of the parking zone information, including parking time charge rate and time limit. The App requests and the vehicle driver confirms the parking location, parking time charge rate, and parking time limit, the last two of which are posted on street signs located in the vicinity of the parking area. Once confirmation takes place on the mobile communication device App, the App, using Bluetooth® or NFC communication link 34, activates and downloads all pertinent information to E-Ticket device 30 and starts its timer and clock functions implemented by microcontroller 42. The driver leaves the vehicle, and parking servers 12 keep track of the time accumulated within the parking time limit. All parking time calculations and transactions take place in parking servers 12; therefore, parking time information is not lost in the event of operational failure of mobile communication device 20 or E-Ticket device 30.

A weak cellular telephone signal or other cause of temporary interruption of connectivity between mobile communication device 20 and parking servers 12 over wireless communication link 18 can result in a delay in parking transaction processing by parking servers 12. A vehicle driver timely making payment for parking could become a victim of the resulting delay in payment processing by parking servers 12 and be vulnerable to receiving an overdue parking time citation. An improperly issued parking citation can result from a parking patrol officer's using portable communication device 40 to perform over communication link 48 a search of parking servers 12 for parking transaction information. The result received from parking servers 12 would reflect not up-to-date and therefore inaccurate parking payment information caused by the payment processing delay. An improperly issued citation for an overdue parking time violation can, however, be reconciled because the vehicle driver's use of the App in the process of paying a parking charge is recorded in memory stores of mobile communication device 20. The App operates to maintain pendency of the vehicle driver's attempted payment transaction until connectivity to parking servers 12 is established and the parking payment process is completed. Parking servers 12 receive from mobile communication device 20 timestamp information demonstrating the vehicle driver's attempt at timely payment for parking. This timestamp information can be used to reconcile the delay and dismiss the parking violation.

With reference to FIG. 3-6, the App's timer operating on mobile communication device 20 keeps track of the elapsed vehicle parking time and alerts the vehicle driver as to the time remaining for the parking area before expiration of the parking time limit. The App also activates E-Ticket device 30 to display the necessary information for a parking patrol officer to see. At the same time, the App opens the vehicle driver's parking transaction account, activates parking servers 12, and communicates to the parking servers the parking time charge rate, parking time zone limit, and the parking start time. The E-Ticket device 30 can either, in a dynamic mode, count the minutes or, in a static mode, show the expiration time so that a parking patrol officer or parking service attendant can recognize whether the vehicle has been parked for a time longer than the specified time limit. Display surface 44 of E-Ticket device 30 can reverse black and white background luminosity, change color, or display a special image after occurrence of the parking expiration time for easy recognition by the parking patrol officer or parking service attendant. As stated above, to reduce the cost of E-Ticket device 30, LEDs may be substituted for display surface 44 to indicate parking time or other information.

The operational procedures implemented in system 10 and the operation of E-Ticket device 30 afford flexibility that allows a municipality to offer a grace period (e.g., 10-15 minutes) after the expiration time for the vehicle driver to return to the vehicle before a parking violation is recorded. The municipality can charge a larger fee for this grace period, thereby generating more revenue for the municipality yet reducing the violation fine the vehicle driver would have incurred.

Recognizing the locations of the vehicle and mobile communication device 20, system 10 can calculate a return time the vehicle driver would need to walk back to the vehicle. System 10 can add to the remaining parking time the calculated return time as reminder time to allow the vehicle driver to return to the vehicle before the parking time has expired.

The App can also drop a pin and recognize the location of mobile communication device 20 to identify the vehicle location by GPS and assist the vehicle driver to find the vehicle as the driver attempts to return to the vehicle.

Upon activation, the App will also provide the vehicle driver with information about activities and business promotions within a short distance from (e.g., 1.5-mile radius) of the parking area. As shown in FIG. 1, parking server 12 is implemented with a wireless communication link 66 with a merchant communication device 68 to enable, with no requirement for parking account validation, delivery of local merchant activity and business promotion information to mobile communication device 20.

With reference to FIG. 3-7, upon return to the vehicle, the vehicle driver uses the App through communication link 18 to stop the timer operating at parking servers 12 and through Bluetooth® or NFC communication link 34 to stop the timer and turn off the clock at E-Ticket device 30. Once the timer is stopped, parking servers 12 calculate the parking charges and record the total parking time and the calculated parking charges so that the municipality receives compensation for the parking fees incurred. In the alternative, as the vehicle driver returns to the car, through recognition of the proximity to E-Ticket device 30 using Bluetooth® communication and Geofencing capabilities of mobile communication device 20, as the vehicle moves several feet, the App automatically turns off E-Ticket device 30 and sends an end of parking signal through communication link 18 to parking servers 12. The end of parking signal received by parking servers 12 activates them to complete the parking payment transaction by recording the total parking time. Upon completion of the transaction, all information (e.g., parking location, date, and charges) is aggregated and recorded on the vehicle driver's account residing on parking servers 12. As a security measure, parking servers 12 send the recorded parking time and fee through communication link 18 to mobile communication device 20.

System 10 is also capable of an automatic start of a parking transaction based on separation distance of mobile communication device 20 and E-Ticket device 30 when connectivity between them is lost and navigation system 16 detects movement of mobile communication device 20 only. This is accomplished after initiation of a parking transaction, and when the pairing connectivity is lost and navigation system 16 detects movement of mobile communication device 20. Parking server 12 provides to mobile communication device 20 the start timer command and thereby starts a parking transaction.

With reference to FIG. 3-8, the vehicle driver using mobile communication device 20 can access the parking payment account at any time to view all parking charges and information.

FIG. 1 shows parking servers 12 established with communication links 70, 72, and 74 through wireless Internet Protocol networks with parking customer accounts of a user/vehicle driver 75, a private parking provider 76, and a municipality 78, respectively. Communication links 70, 72, and 74 enable user/vehicle driver 75, private parking provider 76, and municipality 78 to access parking activity and payment information relating to their respective parking customer accounts.

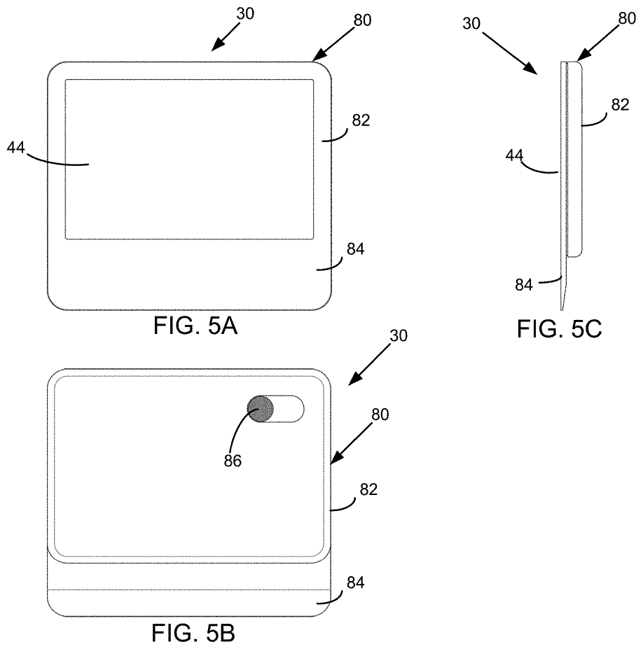

FIGS. 4A and 4B are respective front and rear perspective views of E-Ticket device 30. FIGS. 5A, 5B, and 5C are, respectively, front, rear, and side elevation views of E-Ticket device 30. With reference to FIGS. 4A, 4B, 5A, 5B, and 5C, E-Ticket device 30 includes a housing 80 that has a low profile display portion 82 from which extends a front bezel 84. Display portion 82 has on its front side the display surface 44 and contains in its interior a circuit board and the electrical power supply including battery 52. Microcontroller 42 and the other electronic components are mounted on the circuit board. Extended front bezel 84 is in the form of a thin blade that is configured for insertion into the narrow gap between the vehicle door window and its inside weather strip. Front bezel 84 allows the vehicle driver to insert E-Ticket device 30 with its display surface 44 resting against the inside surface of the door window and visible to a parking patrol officer or parking service attendant observing display surface 44 from outside the parked vehicle.

Display portion 82 has on its rear side a large slidable ON/OFF switch mechanism 86 that provides secure activation of E-Ticket device 30 by the vehicle driver.

To save power and thereby extend battery life, microcontroller 42 of E-Ticket device 30 at specified time intervals (e.g., one-minute intervals) momentarily turns on to advance its timer. Display surface 44 presents all information preferably on a bright white background for viewing at a glance, even in bright sunlight conditions.

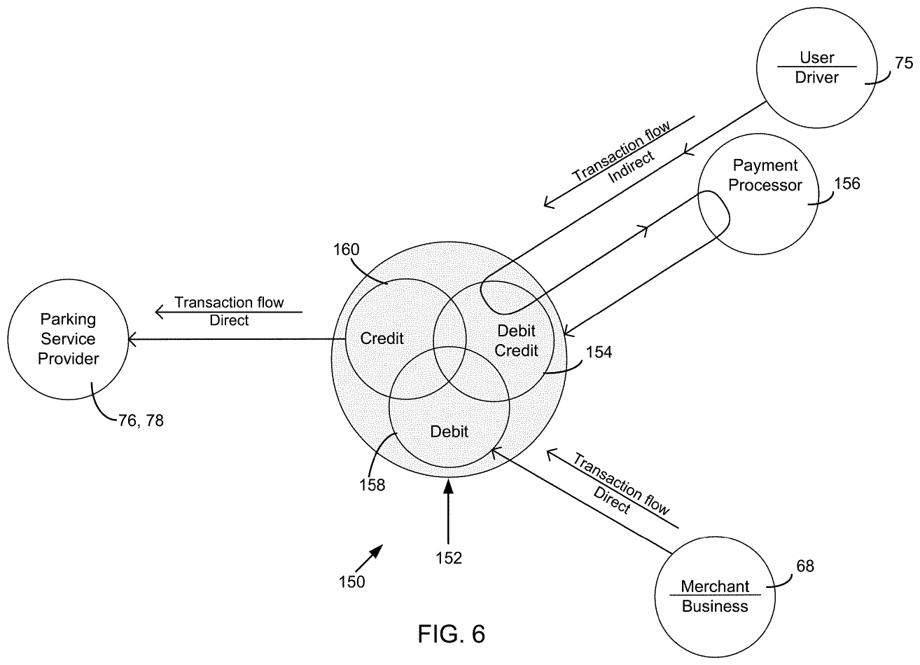

FIG. 6 is a diagram showing a preferred embodiment of a transaction payment processing system 150 that enables a merchant or business to subsidize all or a portion of a customer's transactions. Most, if not all, current backend transaction systems are built for processing one-way transactions (i.e., buying and selling) between two entities, but transaction payment processing system 150 implements a virtual exchange platform that processes both debit (i.e., buying and selling) and credit (i.e., deposit) transactions among multiple entities. The three entities described for the preferred embodiment disclosed include user/vehicle driver's account 75, merchant account 68, and parking service provider account 76 or 78.

With reference to FIG. 6, transaction payment processing system 150 includes a backend transaction system 152 that performs credit and debit processes for multiple user/vehicle driver's accounts 75, merchant accounts 68, and parking service provider accounts 76, 78. Backend transaction system 152 is preferably part of backend or parking servers 12. Transaction payment processing system 150 uses wireless technologies to carry out a method of debiting and crediting multiple ones of each of user/vehicle driver's account 75, merchant account 68, and parking service account 76, 78 with incremental amounts of money over a set period of time. The method facilitates fast processing of multiple micro-transactions (debits and credits) without storing of funds while reducing the cost of payment processing for individual account holders.

The process starts with a user/driver (buyer), a parking service provider (seller), and a merchant opening accounts with backend transaction system 152. Upon a first-of-the-day transaction effected by user/vehicle driver's account 75 with parking service provider (seller) account 76, 78, backend transaction system 152 opens a user-specific tab 154 that allows user/vehicle driver's account 75 to pay for the entire day all of the user/vehicle driver's parking transactions. At the end of the day, backend transaction system 152 sorts and separates any and all credits given that day by merchant account 68. Backend transaction system 152 then applies to user/vehicle driver's account 75 all credits attributed to different amounts charged during the day to offset the sum of user-specific tab 154 before debiting user/vehicle driver's account 75. The process of debiting user/vehicle driver's account 75 is performed by a payment processor company 156, such as, for example, Stripe. This process (1) lowers the amount of debit to user/vehicle driver's account 75, and thereby lowers the transaction fee, which is based on a percentage of transaction monetary payment; and (2) performs only one payment process against the user/driver's credit card, and thereby lowers the transaction cost, which is based on the number of transactions made.

At the same time, upon a first-of-the-day credit effected by merchant account 68, backend transaction system 152 opens a merchant-specific tab 158, allowing merchant account 68 to credit all of its customers during that day. This process lowers the cost of crediting/redemption process for the merchants/businesses. At the end of the day, backend transaction system 152 debits and credits the merchant's bank account (ACH) only once for the sum of all credits given to all user/vehicle driver accounts 75 during that day.

Moreover, upon a first-of-the-day transaction with parking service provider 76, 78, backend transaction system 152 opens a parking service provider-specific tab 160 and keeps track of all transactions between each of multiple system user/vehicle driver's accounts 75 and parking service provider account 76, 78. At the end of the day, a bank deposit equal to the sum of all transactions between each of the multiple user/vehicle driver's accounts 75 and parking service provider 76, 78 is made to that parking service provider's bank account (ACH). This process substantially lowers the cost of transactions by use of credit cards between different users/vehicle drivers and the parking service provider. This method implementing backend transaction system 152 allows merchants and businesses to subsidize the cost of other transactions (e.g., taxi, train, and bus transportation costs and parking costs) carried by the user/driver at a low cost.

In summary, transaction payment processing system 150 enables three-way transactions (debit and credit), lowers transaction and processing costs, makes micro-transactions feasible, makes possible redemption and validation processing of any amount of money, and holds no money within the system at any time. The longer time a tab remains open, the lower the cost of transaction processing.

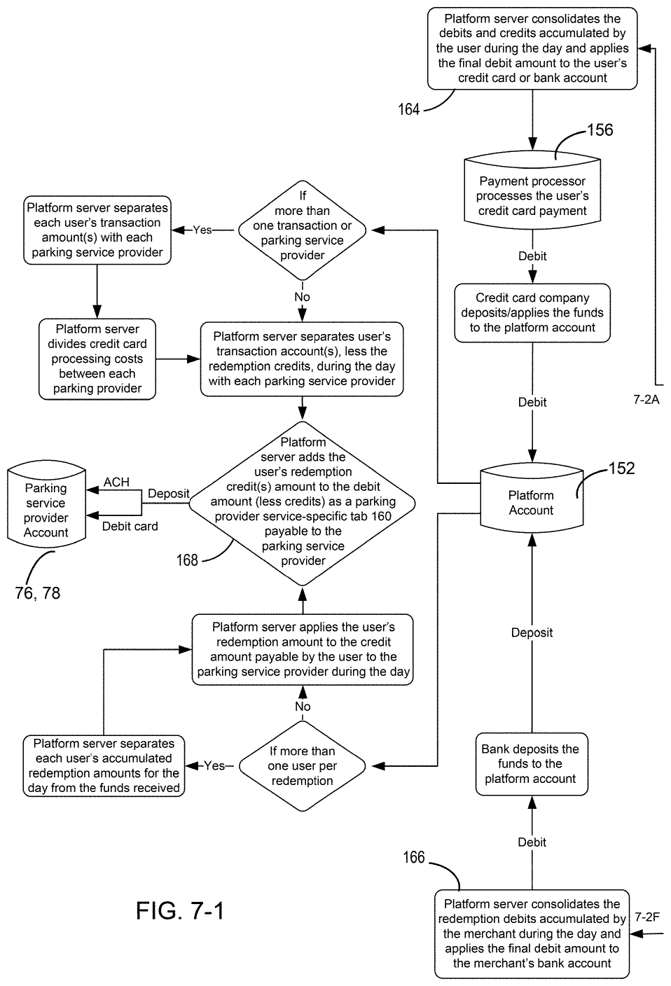

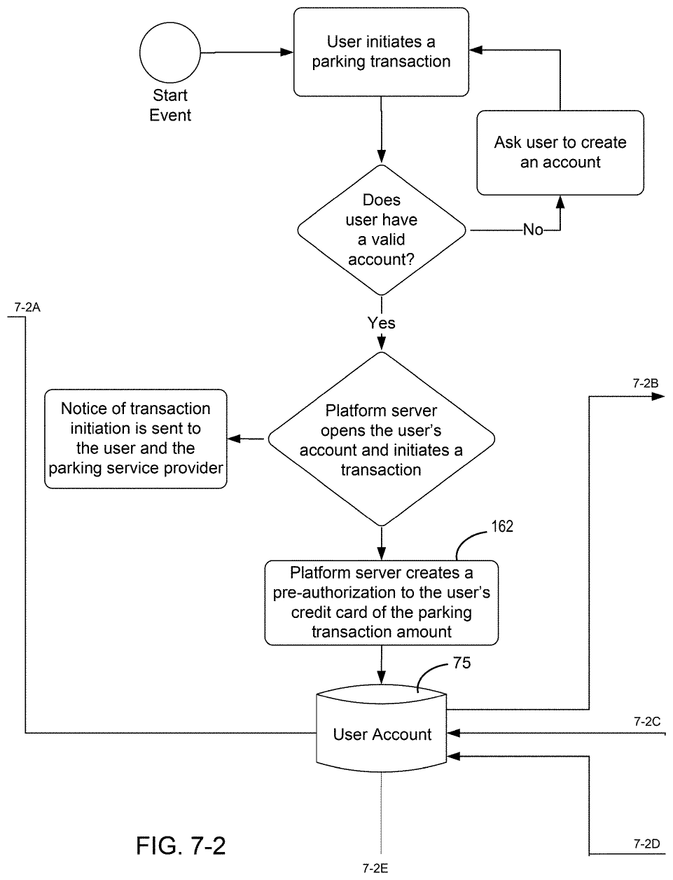

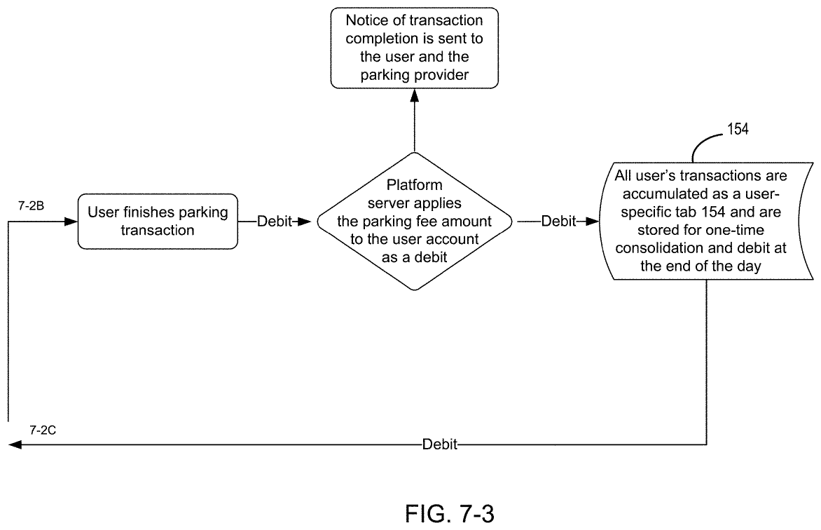

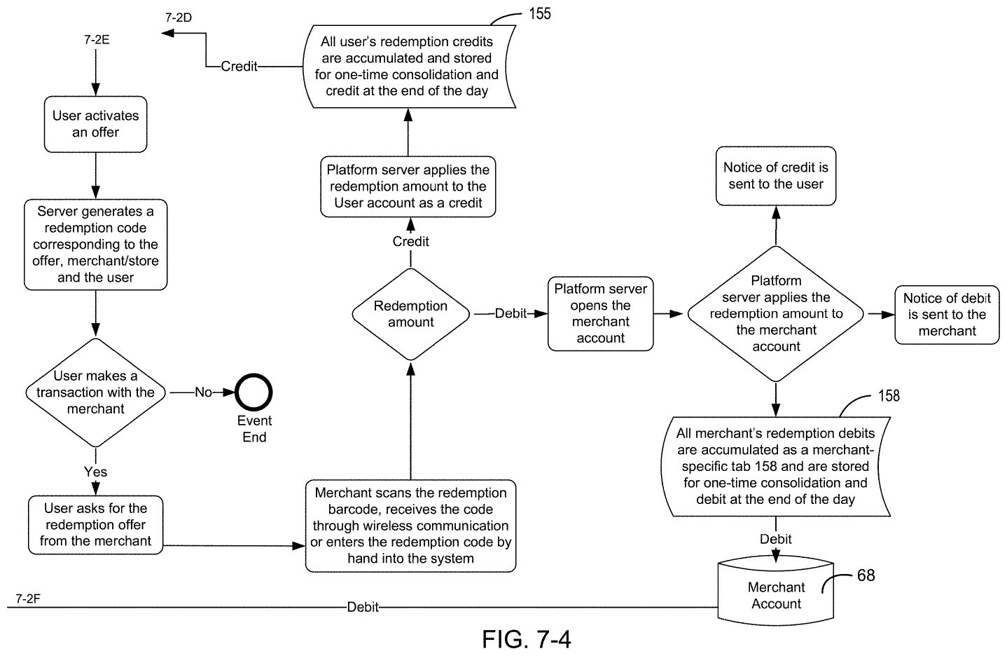

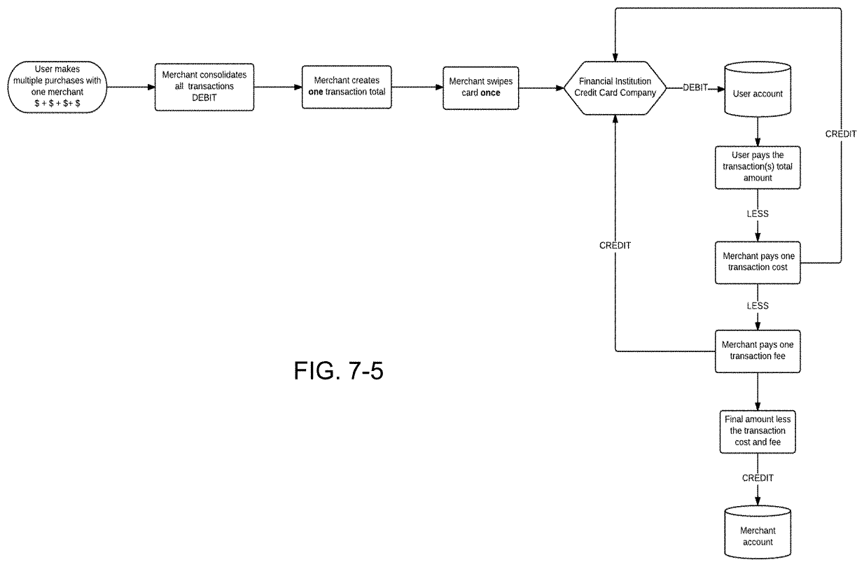

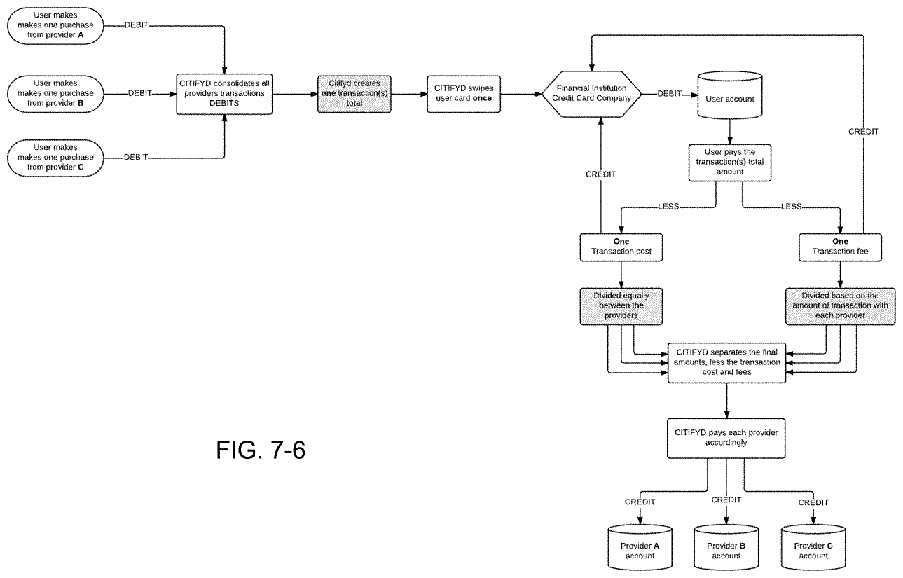

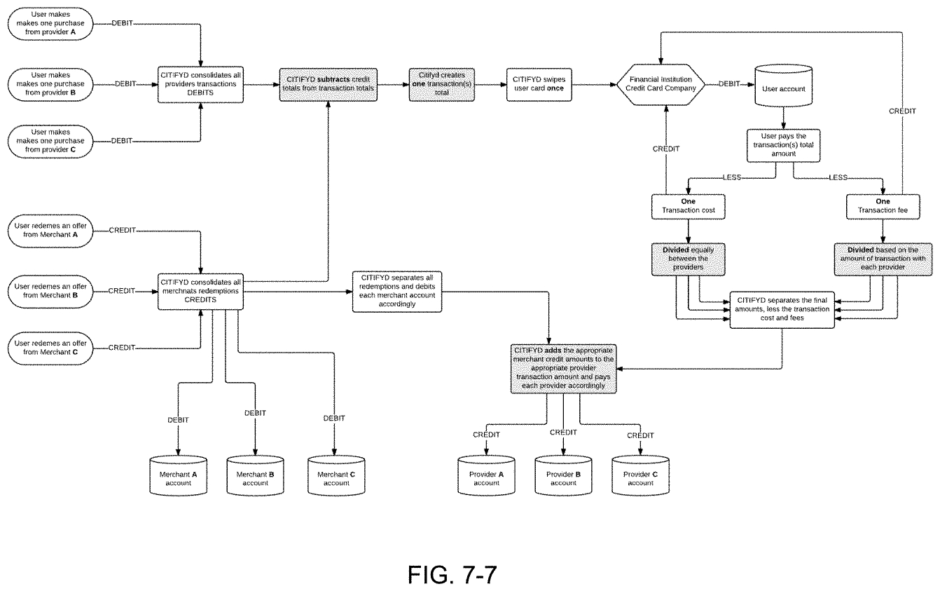

FIG. 7, which includes a set of four drawing sheets (FIGS. 7-1, 7-2, 7-3, and 7-4), is an extensively annotated flow diagram showing and describing the functions performed by transaction payment processing system 150 in carrying out the credit and debit processes described above with reference to FIG. 6. (The last digits of the figure numbers indicate the consecutive order of the drawing sheets as they are assembled from left to right to present the entire flow diagram.)

FIG. 7-2 shows process and decision blocks representing a user/vehicle driver (hereafter “user”) causing a start event that initiates a parking transaction by opening an existing user account or creating a new user account 75. User account 75 either delivers transaction or payment information to or receives transaction or payment information from process block operations described in FIGS. 7-1, 7-3, and 7-4.

FIG. 7-3 shows process and decision blocks representing completion of a parking transaction, processing parking transaction fee amounts, and accumulating a user-specific tab 154 of parking fee amounts for the day.

FIG. 7-4 shows process and decision blocks representing operations performed in response to a user activating a promotional credit offer by a merchant. In the example given, the event ends if the user decides not to effect a transaction with the merchant but continues if the user decides to proceed with the transaction. The remaining operations shown in FIG. 7-4 entail redeeming the merchant's offer; crediting user account 75 (shown in FIG. 7-2), including creating a user-specific tab 155 that accumulates and stores all redemption credits the user claimed during the day; and debiting merchant account 68, including merchant-specific tab 158 that accumulates and stores all redemption debts claimed by all users against the merchant during the day.

FIG. 7-1 shows process and decision blocks representing operations performed in processing the debits and credits accumulated during the day in user account 75 (see flowchart line 7-2A) and applying a final debit amount to the user's credit card or bank account; processing the redemption credits accumulated during the day in merchant account 68 (see flowchart line 7-2F) and applying a final debit amount to the merchant's bank account; and processing funds for deposit as an ACH electronic payment or a debit card payment in parking provider account 76, 78.

Flowchart line 7-2A, directed to the operation of payment processor 156, refers to a platform server consolidating debits and credits accumulated by the user during a transaction period (e.g., day, week, or month) and applying a final debit amount to the user's credit card or bank account. An inherent risk in the described open tab system is that a user account may be valid and exceed a permissible minimum account balance at the beginning of the opening transaction but may have an insufficient account balance or exceed the user's credit limit at the end of the closing of the transaction period.

To reduce the risk of keeping a tab open for a specific amount of time, backend transaction system 152 implements a credit/debit tab system risk management method, which entails the following steps. Upon opening an account, based on one or both of the fixed and hourly rates of the parking provider, the platform server initiates a transaction and preauthorizes the user's account by a specific amount. This preauthorization can happen several times during the parking session(s) and is indicated as a process block 162 in FIG. 7-2. Upon the conclusion of the parking session(s), after all debits and credits are accounted for, charges are added to and credits are subtracted from the preauthorization amount(s) and the transaction is closed.

Over time, the credit/debit tab system creates for each user a risk profile based on the user's vehicle parking behavior pattern (i.e., vehicle parking frequency and duration) and transaction amounts incurred for each use. This historical record of parking charges further adjusts the preauthorization amount and the number of times that preauthorization can take place during the open transaction period.

FIG. 7-1 refers to a platform server and a platform account, both of which are components of backend transaction system 152. The processing of funds to parking provider account 76, 78 proceeds along two paths, one path relating to a decision block determining whether there is more than one user for each redemption and the other path relating to a decision block determining whether there is more than one transaction or parking service provider. Depending on the situation determined for each path, the platform server determines the amount payable to parking provider account 76, 78 in accordance with the process flow shown and described in FIG. 7-1.

The payment processing cost saving benefit is especially pronounced in the operation of a transaction payment processing system for a practical situation in which subscriber account holder entities include a set of multiple user accounts 75, a set of multiple merchant accounts 68, and a set of multiple provider accounts 76, 78. A typical user account over time makes one or more purchase transaction payments to each of several members in the set of provider accounts 76, 78. A typical user account 75 over time takes advantage of, by redeeming, one or more merchant credit offer transaction payments made available by each of several members in the set of merchant accounts. Transaction payment processing system 150 operating in association with the backend servers 12 organizes as follows the purchase transaction payments by the user accounts to the provider accounts and the merchant credit offer transaction payments by the merchant accounts to the user accounts.

Processing system 150 consolidates, as user debits, for each user account 75, the purchase transaction payments made to each member in the set of provider accounts 76, 78 with which the user account 75 transacted business and accumulated over a transaction period. Processing system 150 also consolidates, as user credits, for each user account 75, the merchant credit offer transaction payments given by each member in the set of merchant accounts 68 with which the user account 75 redeemed a credit offer and accumulated over a transaction period. Processing system 150 consolidates, for each user account 75, the user debits and user credits attributed to each provider account 76, 78 to obtain, for a first transaction period, a final user debit amount (FIG. 7-1, process block 164). The final debit amount payable to each provider account 76, 78 is the difference of the user credits from the user debits attributed to each provider account 76, 78. The duration of the first transaction period over which the final user debit amounts for the providers are calculated may be selectable by the system operator or the merchant account holder.

Processing system 150 consolidates, as merchant debits, for each merchant account 68, the merchant credit offer transaction payments made to each member in the set of user accounts 75 with which the merchant transacted business and accumulated over a transaction period. Processing system 150 consolidates, for each merchant account 68, the merchant debits attributed to the merchant account 68 to obtain, for a second transaction period, a final merchant debit amount (FIG. 7-1, process block 166). The duration of the second transaction period over which the final merchant debit amounts are calculated may be selectable by the system operator or the merchant account holder.

Processing system 150 consolidates, as provider credits, for each provider account 76, 78, the purchase transaction payments, less the merchant credit offer transaction payments, made by each member in the set of user accounts 75 with which the provider account 76, 78 transacted business and accumulated over a transaction period. Processing system 150 also consolidates, as provider credits, the merchant credit offer transaction payments made to each member in the set of user accounts 75 with which the provider account 76, 78 transacted business over the transaction period. (This latter provider credit allocates to the provider account the merchant credit offer payment that is made to the user account but is not the responsibility of the provider account holder.) Processing system 150 consolidates, for each provider account 76, 78, the provider credits attributed to the provider account 76, 78 to obtain, for a third transaction period, a final provider credit amount (FIG. 7-1, decision block 168). The duration of the third transaction period over which the final provider credit amounts are calculated may be selectable by the provider account holder.

The above-described transaction payment process reduces processing costs for the following reason. The single final provider credit amount payable to each provider account represents the sum of the payments for provider transactions of all user accounts for that provider account. The processing system makes one payment by ACH or debit card payment to the parking provider account for each user account, which held during the transaction period multiple purchase transactions for which multiple payments to the provider account would otherwise had to have been made. This reduces the overall number of payment transactions attributable to each provider account and thereby reduces the payment transaction costs such as credit card transaction processing paid by system 10. Each provider account benefits from the reduction in credit card transaction processing costs, and processing system 150 can allocate equally the reduced payments of credit card processing costs among the provider accounts. Each provider account benefits also from the reduction in credit card processing fees, which are calculated as a percentage of the total monetary amount of the payment made. Processing system 150 can allocate on a proportional basis the reduced payments of credit card processing fees among the provider accounts.

FIG. 7-5 is a flow diagram of a conventional multi-transaction process in which one user makes multiple purchases from one merchant. This payment process affords no reduction in credit card processing cost or fee.

FIG. 7-6 is a flow diagram of a multi-transaction process in which one user makes one purchase from each of three providers (Providers A, B, and C). FIG. 7-7 is a flow diagram of a multi-transaction process in which one user makes one purchase from each of three providers (Providers A, B, and C) and redeems a credit offer from each of three merchants (Merchants A, B, and C). FIGS. 7-6 and 7-7 refer to CITIFYD, which is the operator of system 10.

The shaded process blocks indicate the process steps that contribute to lower credit card processing costs and fees. The process steps include one total transaction after consolidation of user account transaction debits (FIG. 7-6); subtraction of a consolidation of merchant account redemption credits from a consolidation of user account transaction debits (FIG. 7-7); division of one transaction cost and division of one transaction fee among the three provider accounts (FIGS. 7-6 and 7-7); and, after payment to a financial institution or credit card company, addition of merchant credit amounts to their associated provider accounts (FIG. 7-7).

The lower processing cost results from fewer payment transactions, and the lower processing fee results from direct payment of the merchant credit amounts to the three providers after payment to the financial institution or credit card company. The direct payment of the merchant credit amounts reduces the amount payable to the financial institution or credit card company and, therefore, reduces the transaction fee charged.

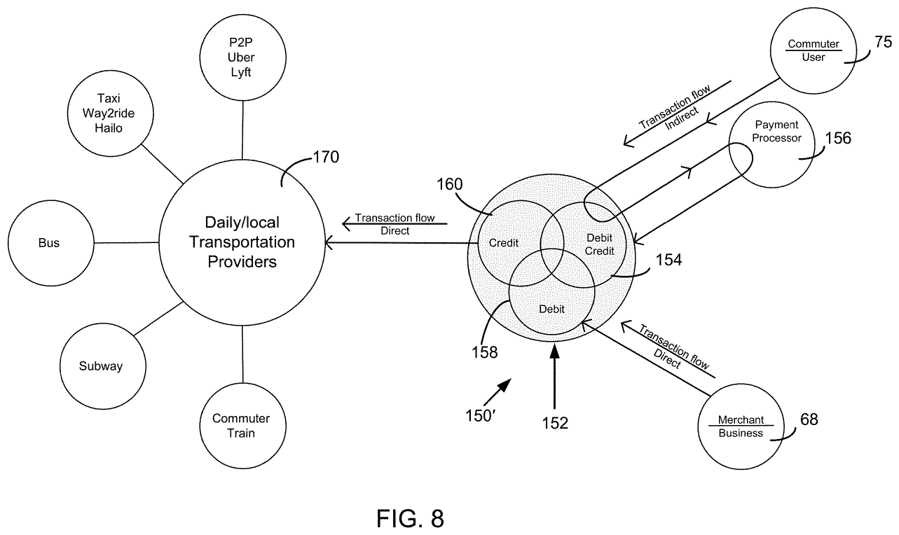

FIG. 8 is a block diagram showing an alternative preferred embodiment of a transaction payment processing system 150′, in which daily/local transportation service providers accounts 170 substitute for parking service provider account 76, 78 of transaction payment processing system 150. The transactions between a user (e.g., a commuter) and any one of the exemplary transportation service providers shown and the credit and debit processing of backend transaction system 152 of transaction payment processing system 150′ are analogous to those of transaction payment processing system 150.

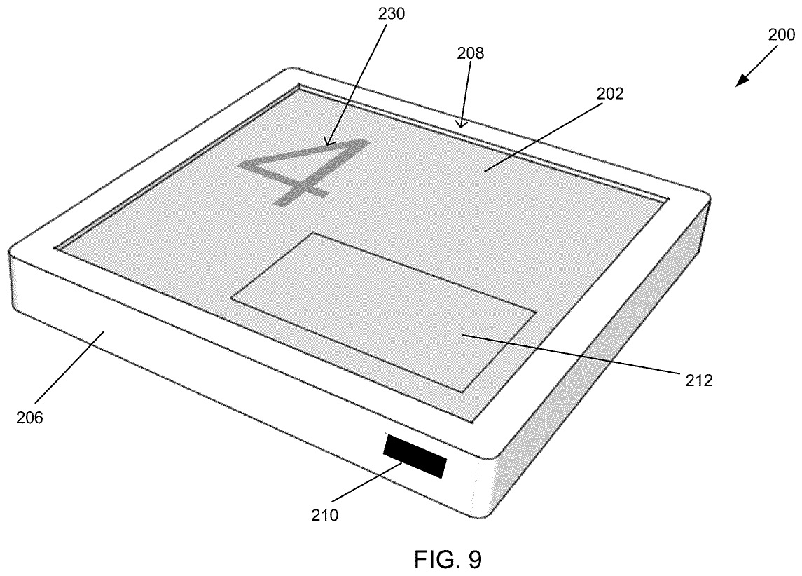

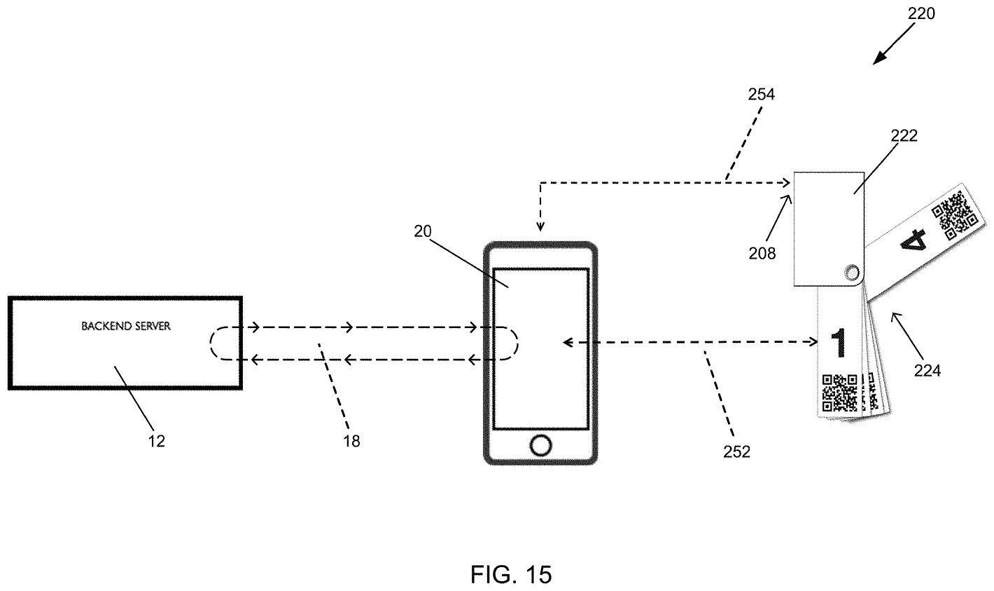

FIGS. 9-16 show several validation beacon device embodiments and the interaction and connectivity of their components to achieve a flexible, secure merchant redemption and validation process that reduces the role of a merchant communication device in performing product or service purchases from a merchant.

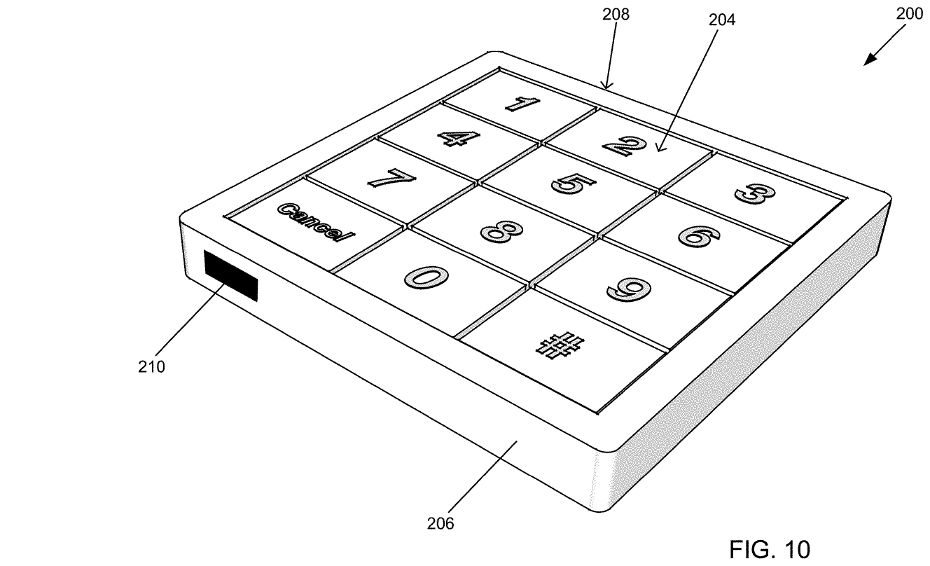

FIGS. 9 and 10 are perspective views of, respectively, the top and bottom of a validation beacon device embodied as a self-contained electronic display module 200. Display module 200 includes an electronic paper display 202, such as an E Ink electronic paper display, on the top surface and a numeric keypad 204 on the bottom surface of a low profile durable, water tight module housing 206. Module housing 206 contains a beacon signal transmitter 208 that emits a short-range beacon signal carrying identifier information for reception by user mobile communication device 20 for the reasons described below. Module housing 206 also contains memory stores for storing a set of redemption or credit codes of available credit offer transaction payments, electronic circuitry, and a power supply such as a rechargeable battery, all of which are not shown. A USB port 210 enables use of a USB connection to replace and download a new set of credit codes into display module 200. Credit codes in the form of barcodes or QR codes are digitally displayed on electronic paper display 202 as images 212 suitable for scanning by user mobile communication device 20.

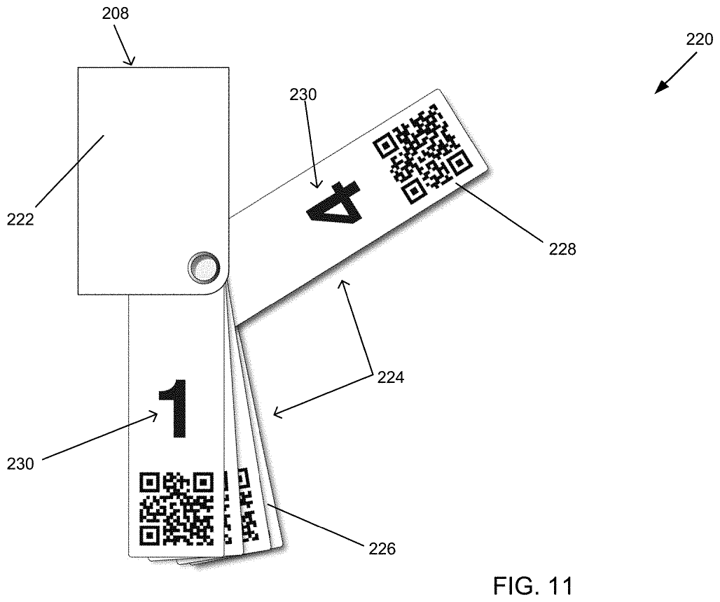

FIG. 11 is a plan view of a validation beacon device embodied as a small, thin profile self-contained beacon unit 220 having a housing 222 to which is attached a set 224 of substrates or cards 226 on which are printed barcodes or QR codes 228 and a corresponding number 230. Number 230 identifies each separate card included in set 224 of cards 226. Cards 226 are preferably made of plastic or cardboard. Unit housing 222 contains beacon signal transmitter 208, electronic circuitry, and a rechargeable battery power supply, the last two of which are not shown.

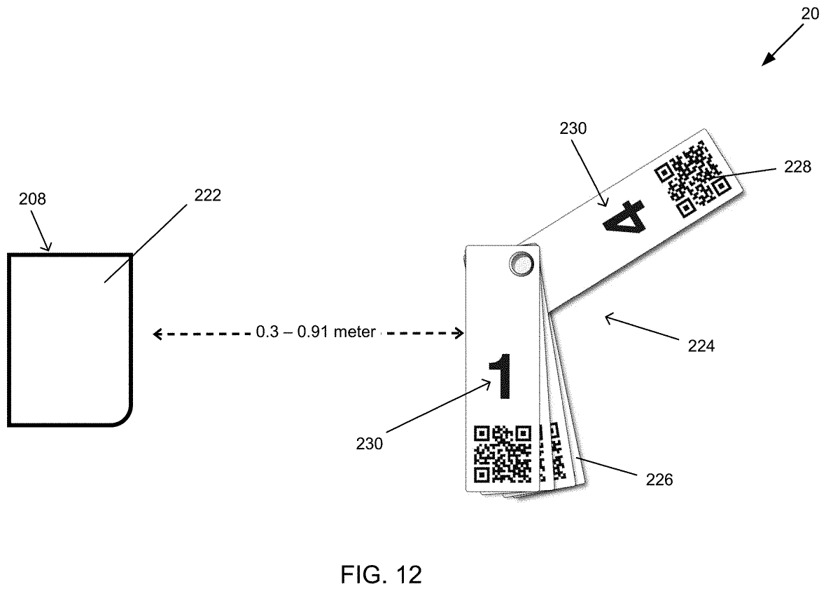

FIG. 12 is a plan view of a validation beam device embodied as a small, thin profile self-contained beacon unit 240 of similar design to that of beacon unit 220, with the exception that set 224 of cards 226 is physically separate from unit housing 222. The 0.3-0.91 meter distance between housing 222 of beacon unit 240 and set 224 of cards 226 shows the distance range for secure operation of credit code validation using the validation beacon device 240 configuration of FIG. 26.

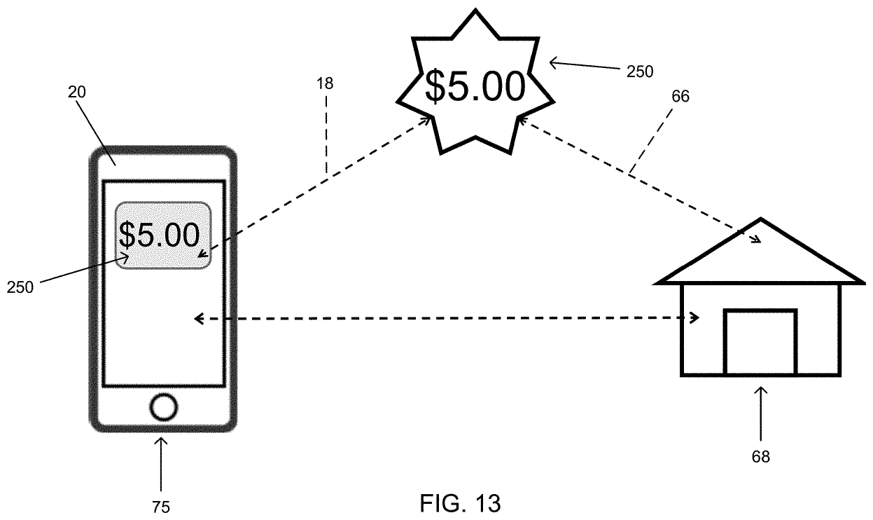

FIG. 13 is a simplified diagram showing the correlation between user account 75 and store or merchant account 68 in securely carrying out a merchant credit offer authorization and validation process. With reference to FIG. 13, once the user selects the merchant and its credit offer 250 sent by backend server 12 and appearing on user mobile communication device 20, system 10 generates an activation/redemption message on mobile communication device 20 and connects user account 75 to credit offer 250 and to merchant account 68. Upon the user's completion of the activity requested by credit offer 250 (e.g., transaction, entering the store, or using its services), the user can then redeem credit offer 250 from the merchant.

To redeem the offer, the merchant presents to the user a barcode or QR code image 212, 228 to be scanned 252 by user mobile communication device 20. The merchant's validation barcode or QR code scan 252 authorizes system 10 to debit merchant account 68 and credit user account 75 for the amount of the credit offer. Each merchant validation barcode or QR code has the merchant's account number, store ID, and the number of the offer item. For example, if the offer is for a monetary amount of purchase (e.g., a $5.00 redemption for any purchase of $40.00 and more) then only one barcode or QR code is necessary. However, if the offer is for each item purchased (e.g., $1.00 for every coffee beverage ordered), then several barcodes or QR codes 212 on electronic paper display 202 or barcodes or QR codes 228 on several cards 226 in set 224 of cards are necessary (one for each number of items). The numeral “4” shown on electronic paper display 202 represents the number of items ordered. The merchant or a store clerk uses numeric keypad 204 to enter the number of items ordered.

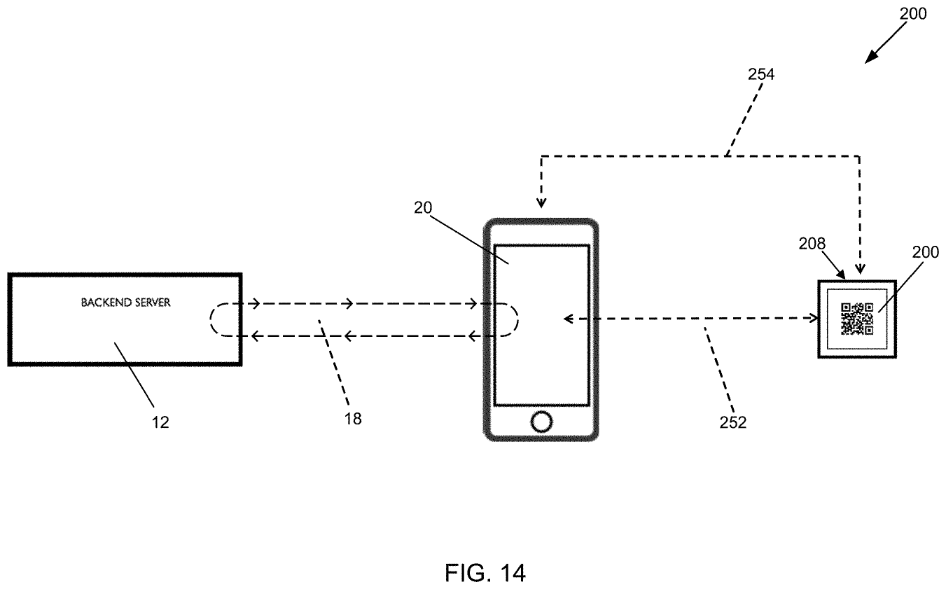

FIGS. 14, 15, and 16 show the interaction and connectivity paths configured to achieve secure credit code validation in the use of the validation beacon device module 200, unit 220, and unit 240, respectively. To reduce fraud and theft of unauthorized merchant credit payments, such as by a user taking a photograph of the barcode or QR code while performing a scan 252 during a purchase transaction and thereafter scanning the photograph multiple times away from the merchant without completion of the activity requested by the credit offer to fraudulently redeem additional merchant credit payments, a validation beacon device 200, 220, or 240 is placed nearby barcode or QR code image 212 or 228. Only when the user mobile communication device 20 has received a handshake 254 from the beacon (authentication and unlocking process), then scanned barcode or QR code 210 or 228 is validated and confirmed. The beacon emitted from beacon transmitter 208 in display module 200, attached to beacon unit 220, or in proximity of the barcode or QR code (e.g., one meter) to beacon unit 240 is used to establish a pairing connection with user mobile communication device 20. A pairing connection can be achieved because the App operating on user mobile communication device 20 is compatible with beacon signal transmitter 208 to pick up the identification information carried by the emitted beacon signal. The required close proximity of the beacon and the barcode or QR code image 212, 228 necessitates that the scan take place in the presence of one or both of the merchant and clerk.

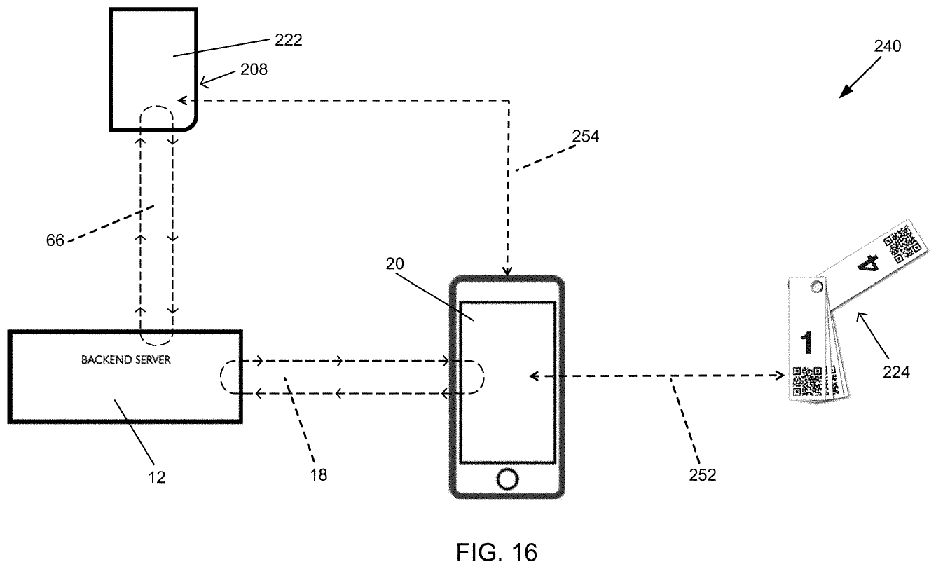

The secure credit code validation processing scenarios depicted in FIGS. 14, 15, and 16 show that user mobile communication device 20 forms a wireless communication link with server 12, and FIG. 16 shows that beacon unit 240 also forms a wireless communication link with server 12.

For additional security, a Geofence created around the merchant's store facility also ensures that the redemption takes place within the close proximity of the merchant.

An embodiment based on the configuration and operation of transaction payment processing system 150 is a virtual exchange platform in which otherwise non-affiliated businesses form a business ecosystem or community to provide transferrable customer rewards.

Existing business/merchant/credit card company reward systems, for example, punch cards, allow for accumulation of rewards in the form of points or cash over time for redemption by the customer at the physical location or online site of the same business or merchant. A method of virtual reward exchange model disclosed below allows any business, such as, for example, a merchant, service provider, credit card company, or other business entity, to offer rewards that can be redeemed by any other participating business, thereby creating a community of businesses supporting one another. The business community formed by the participating businesses, especially brick-and-mortar retail businesses, is better positioned to compete against large online retail companies that make direct sales to customers and provide a platform for other retail companies to sell their products to customers. The method allows customers/users to receive and redeem rewards from online commerce to offline commerce and vice-versa. The disclosed method replaces punch card rewards (or similar types of rewards) offered by a merchant, while allowing all other participating merchants to accept and honor the rewards of other merchants participating in the business community. The participating businesses could be online businesses or offline businesses, including physical stores.

The virtual exchange platform allows any online or offline business to offer rewards to its customers and have the rewards redeemed at its own online location, offline location, or both, or credited to its customer account at any time after receiving the reward. The platform also allows any online or offline business to offer rewards to its customers and have the rewards redeemed at other online or offline businesses as full or partial payment for their products, services, or both. If desired, the rewards also could be redeemed as cash or be transferred to another customer by a rewards holder.

A business creating a rewards offer (e.g., points or monetary rewards) can set on the platform a parameter of rewards redemption such that certain services, merchants (e.g., competitors), or both, located in proximity to the business (e.g., one-mile radius) would not be eligible to accept its rewards. A business creating a rewards offer (e.g., points or monetary rewards) can set on the platform a parameter of rewards redemption specifying that its rewards to be of higher or lower value if they are redeemed at the online or offline locations of the business (or of a participating partner service provider or merchant business), for certain services, by certain merchants, or both.

The virtual exchange method carried out on the virtual exchange platform can be advantageously practiced by members of a community of businesses allied in support of one another by exchanging member transaction credits to stimulate commercial activity among the member businesses. Member transaction credits in the form of, for example, business community points or monetary units, are fungible in that they are not inextricably connected to exchange of specific goods or services offered by member businesses participating in a commercial transaction. For example, a member plumbing company need not render plumbing services to use its member transaction credits in exchange for purchase of a meal at a member restaurant.

A business member can use its accumulated member business credits from many other member businesses against any future transaction, such as purchasing a product, using a service, or attending an event. Moreover, a business member redeeming member transaction credits can set the amount of credit applied to purchase of a product, use of service, or attendance at an event. The member transaction credit amount selected can be full value, or fraction of the value, of the transaction.

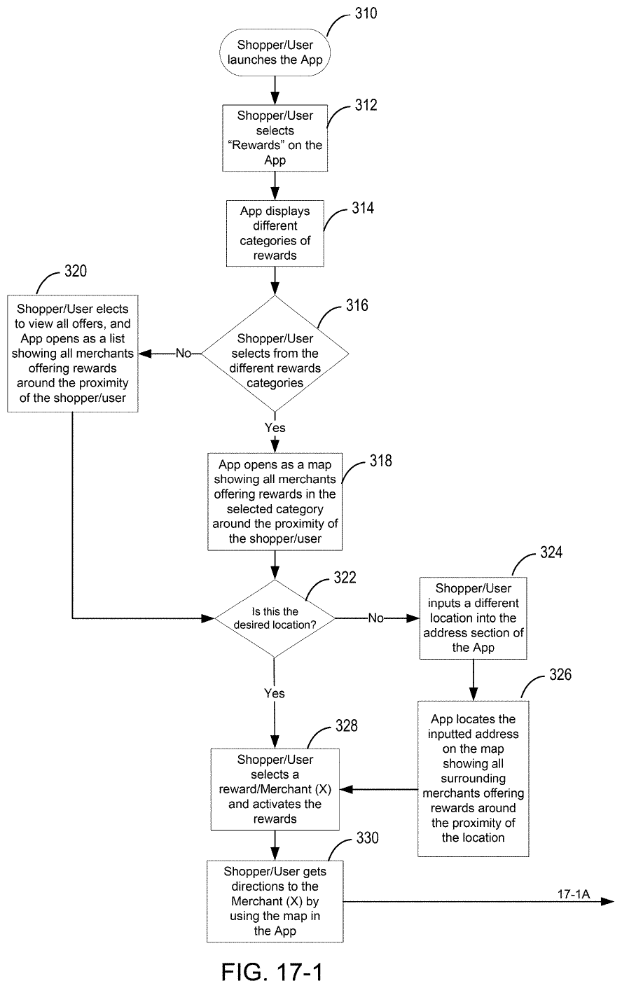

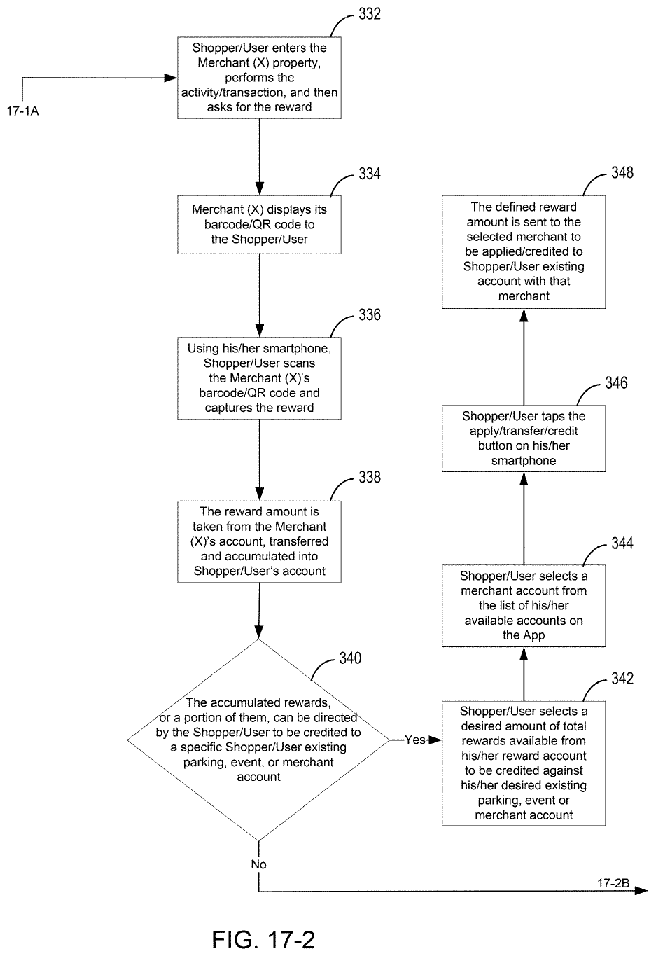

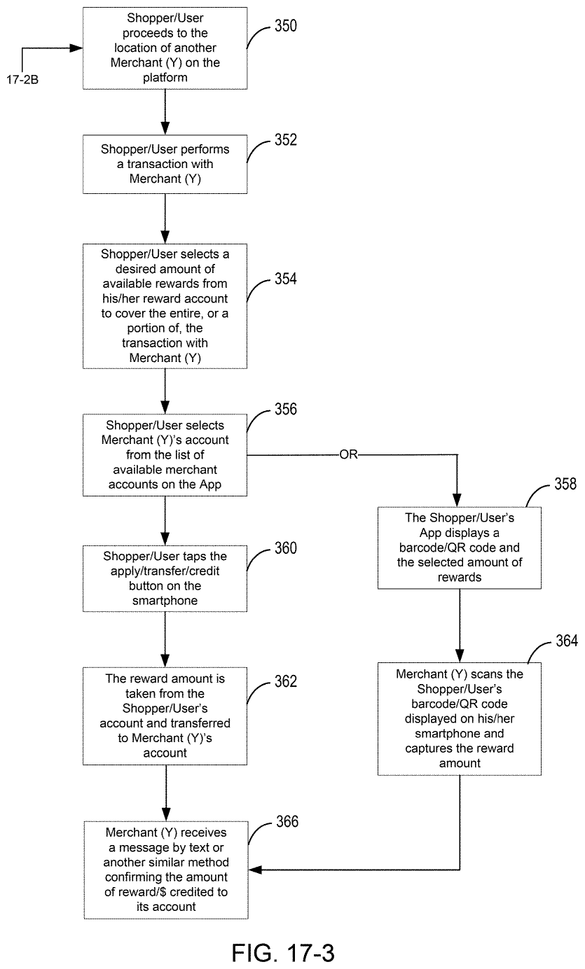

FIG. 17, which includes a set of three drawing sheets (FIGS. 17-1, 17-2, and 17-3), is an extensively annotated flow diagram showing and describing the functions performed by transaction payment processing system 150 in carrying out the disclosed virtual exchange method for member transaction credits or business rewards. (The last digits of the Figure numbers indicate the consecutive order of the drawing sheets as they are assembled from left to right to present the entire flow diagram.)

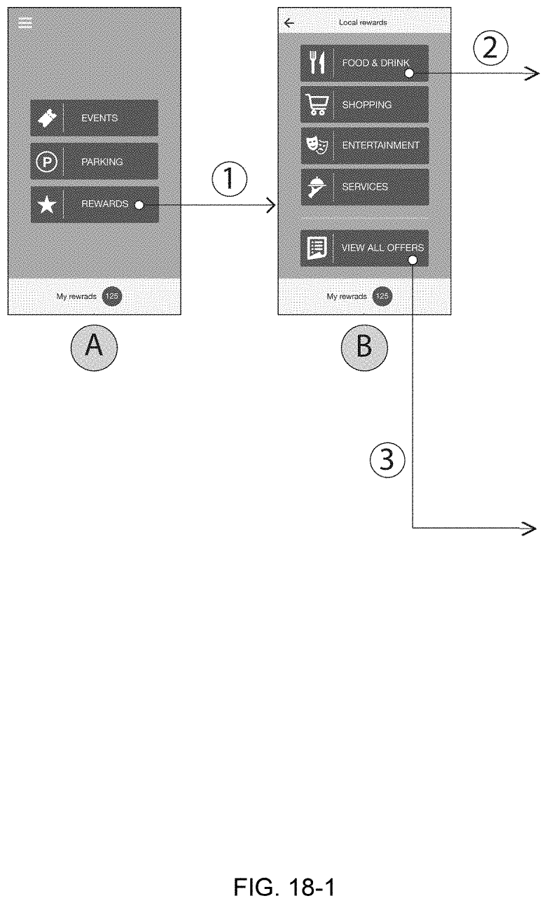

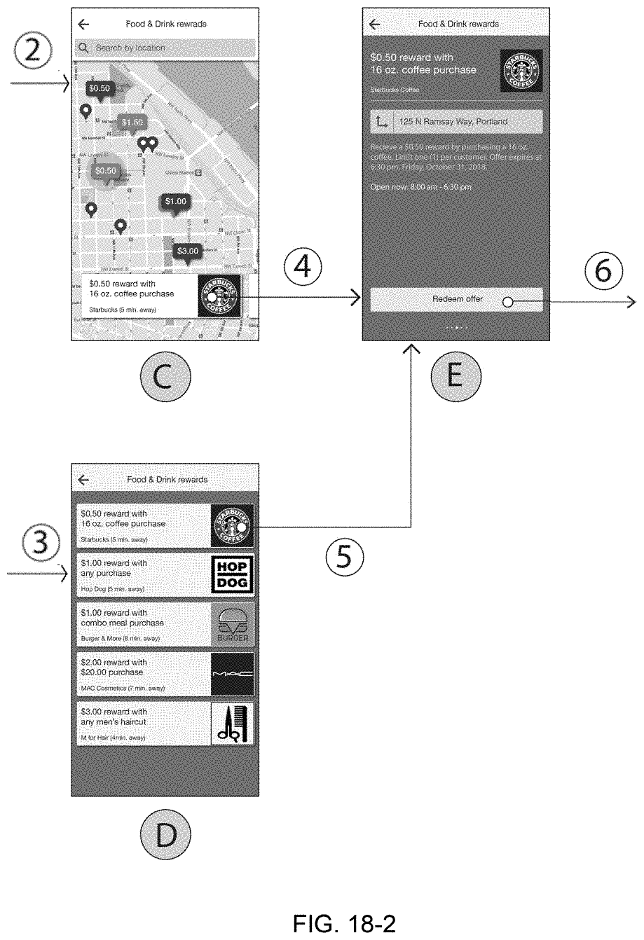

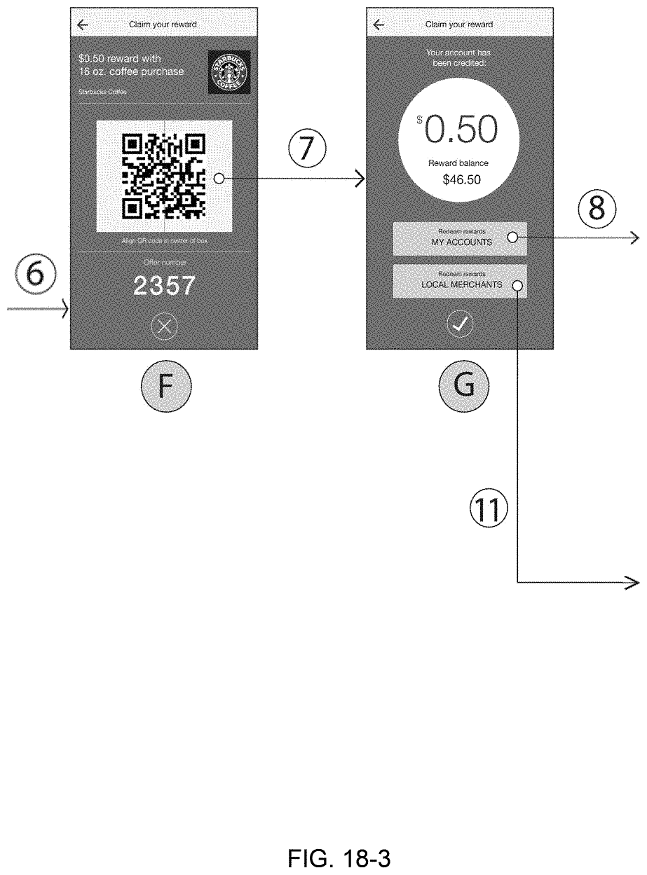

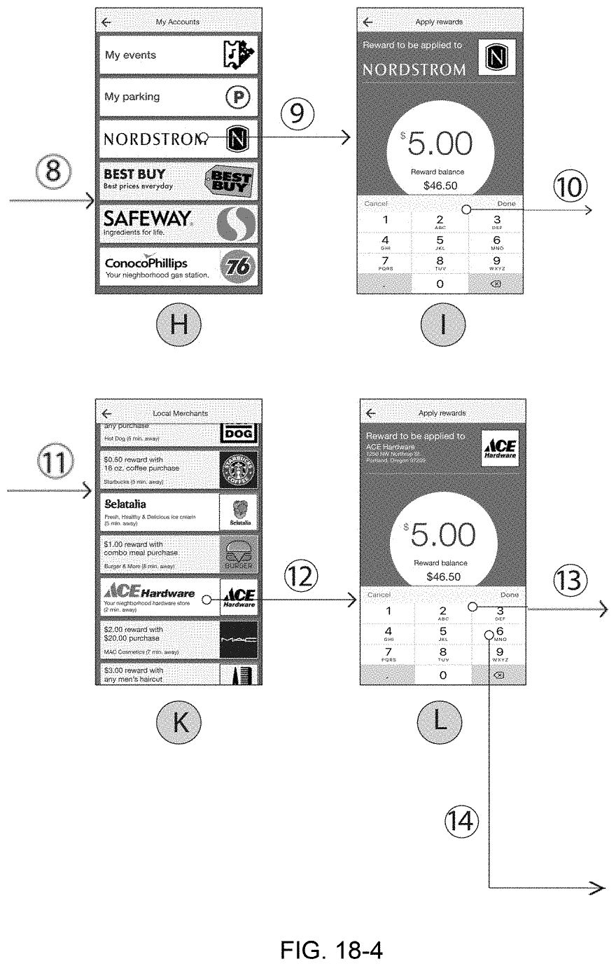

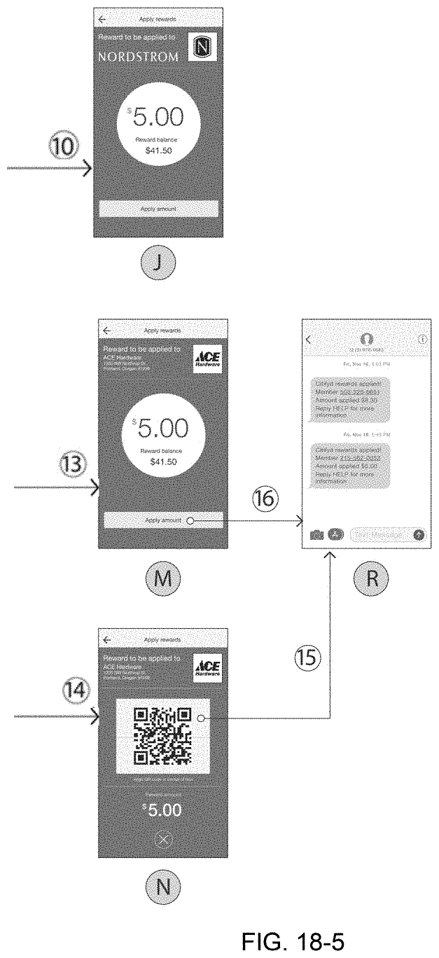

FIG. 18, which includes a set of five drawing sheets (FIGS. 18-1, 18-2, 18-3, 18-4, and 18-5), is a flow diagram of screenshots showing information displayed on mobile communication device 20 for different interactions with system 150. On FIG. 18, a screenshot is represented by a circle enclosing a capital letter; and links between successive screenshots are represented in time order by circles enclosing Arabic numerals. These screenshots show what a rewards holder would observe while redeeming a reward during purchase of a product or service.

The following describes, with reference to the process flow diagram of FIG. 17 in association with sequences of screenshots of FIG. 18 showing information displayed on mobile communication device 20, a scenario of practicing the disclosed exchange method for business rewards.

FIGS. 17-1, 17-2, and 17-3 show process and decision blocks representing a rewards holder, referred to as a Shopper/User, causing a start event that initiates purchase of a product offered by a business participating in a customer rewards program.

With reference to FIG. 17-1, process block 310 indicates the Shopper/User launching the Citifyd App that was loaded on mobile communication device 20 to implement the virtual exchange reward system. Process block 312 indicates the Shopping/User actuating a Rewards selection on a Menu page shown in FIG. 18-1, Screen A. Process block 314 indicates a display of different categories of rewards made available by participating merchants, as shown in FIG. 18-1, Screen B.

Decision block 316 indicates whether the Shopper/User selects a specific category of reward (Yes) or instead elects to view all available offers of rewards (No). For the case in which the Shopping/User selects a specific reward category, process block 318 indicates opening of the App to show a map that identifies all merchants offering rewards in the selected category and located in proximity to the location of the Shopper/User. The map is shown in FIG. 18-2, Screen C. For the case in which the Shopper/User elects to view all available offers of rewards, process block 320 indicates opening of the App to show a list of merchants offering rewards and located in proximity to the location of the Shopper/User. The list is shown in FIG. 18-2, Screen D.

Decision block 322 indicates an inquiry as to whether the location presented is acceptable to the Shopper/User. If the location is not acceptable, process block 324 indicates the Shopper/User using the App to specify in an on-screen address section a specific location of interest. Process block 326 indicates the App showing the Shopper/User-specified location on the map that was opened, as described for process block 318. Process block 328 indicates, for each of the two alternative location-related decisions made in response to the inquiry of decision block 322, the Shopper/User's selection of a reward in the form of an offer by a Merchant (X) of a $0.50 reward to the purchase price of a 16 oz. cup of coffee, as shown in FIG. 18-2, Screen E. Process block 330 indicates that the Shopper/User refers to the map shown in FIG. 18-2, Screen C, for directions to find Merchant (X)'s location, also as shown in FIG. 18-2, Screen E.

With reference to FIG. 17-2, process block 332 indicates the Shopper/User performing a transaction at Merchant (X)'s property and requesting a reward, which is shown in FIG. 18-3, Screen F, as the $0.50 reward on a coffee purchase.

Process block 334 indicates Merchant (X) presenting its barcode or QR code to the Shopper/User, and process block 336 indicates the Shopper/User using a smartphone to scan the barcode or QR code to capture the reward. FIG. 18-3, Screen F, shows the Shopper/User aligning the smartphone with the QR code to claim the $0.50 discount reward.

Process block 338 indicates the $0.50 discount reward amount being taken from Merchant (X)'s account for transfer to and accumulation in the Shopper/User's account.

Decision block 340 indicates a choice by the Shopper/User either to direct an entire amount or a portion of the accumulated rewards for credit against a specific current service provider such as vehicle parking, event, or merchant account (Yes) or to apply as a credit in connection with a later transaction with a different merchant (No). FIG. 18-3, Screen G, shows the App presenting two on-screen redeem rewards buttons from which the Shopper/User can actuate to effect a selection.

Process block 342 indicates the case in which the Shopper/User has chosen to select a desired amount of total rewards available for credit against an existing service provider such as vehicle parking, event, or merchant account. Process block 344 indicates the Shopper/User selecting a merchant account from a list of available accounts presented on-screen by the App, as shown in FIG. 18-4, Screen H. Process block 346 indicates the Shopper/User's selection of a specific merchant account by actuating a button representing a luxury department store, as shown also in FIG. 18-4, Screen H. Process block 348 indicates sending the defined reward amount ($5.00) to the selected department store merchant, as shown in FIG. 18-4, Screen I, for application to the Shopper/User account with the selected department store merchant, as shown in FIG. 18-5, Screen J.

With reference to FIG. 17-3, process block 350 indicates the case in which the Shopper/User has chosen to proceed to the location of another merchant, Merchant (Y), participating in the customer rewards program.

Process block 352 indicates the Shopper/User performing a transaction with Merchant (Y), by actuating a button representing a hardware retail cooperative, as shown in FIG. 18-4, Screen K.

Process block 354 indicates the Shopper/User selecting a desired reward amount ($5.00) of rewards available from the Shopper/User's account to cover the entire, or a portion of the, transaction with Merchant (Y), as shown in FIG. 18-4, Screen L.

Process blocks 356 and 358 represent two alternative methods of payment by the Shopper/User to Merchant (Y). Process block 356 indicates a first method of payment in which the Shopper/User selects Merchant (Y)'s account from a list of available accounts presented on-screen by the App, as shown also in FIG. 18-4, Screen K. Process block 360 indicates the Shopper/User asserting by tapping a control actuator, displayed as a button icon on the Shopper/User's smartphone, to generate an apply/transfer/credit payment command; and process block 362 indicates the reward being taken from the Shopper/User's account and transferred to Merchant (Y)'s account, as shown in FIG. 18-5, Screen M. Process block 358 indicates a second method of payment in which the App displays on Shopper/User's smartphone a barcode or QR code to Merchant (Y), and process block 364 indicates Merchant (Y) capturing the reward amount by scanning the displayed barcode or QR code. FIG. 18-5, Screen N, shows the QR code display for capture of the $5.00 reward amount. Another implementation of the second method of payment entails the App displaying on Shopper/User's smartphone a scanning box for scanning Merchant (Y)'s barcode or QR code, which is printed on a substrate, such as a card, or otherwise displayed on an electronic device. The Shopper/User aligns the smartphone with Merchant (Y)'s barcode or QR code so that the scan box captures Merchant (Y)'s information, causing the platform server to credit the award amount to Merchant (Y)'s account.

Process block 366 indicates, for each of the alternative payment methods represented by process blocks 356, 360, and 362 and by process blocks 358 and 364, Merchant (Y) receiving a message by text or similar method confirming the amount of reward money credited to Merchant (Y)'s account, as shown in FIG. 18-5, Screen R.

It will be obvious to those having skill in the art that many changes may be made to the details of the above-described embodiments without departing from the underlying principles of the invention. For example, a third party, such as a customer of one of the member businesses, could hold member transaction credits by transfer from a member business and redeem them for goods and services provided by another member business. The scope of the present invention should, therefore, be determined only by the following claims.

1. A transaction payment processing system implementing a virtual exchange platform that processes debit and credit transactions among multiple subscriber account holder entities, the multiple subscriber account holder entities including a user, a provider, and a merchant holding, respectively, a user account, a provider account, and a merchant account, each of the provider and merchant providing a product or service available for purchase by the user, and the provider account and the merchant account set up in the system to conduct financial transactions with the user account, the system comprising:
a platform server on which are stored account information of provider accounts of multiple providers, a merchant account, and a user account, the platform server including communication signal interfaces configured to establish communication links with communication devices associated with the provider, merchant, and user accounts, and the multiple providers and merchant being members of a community of businesses offering to users business community member transaction credits;
a first wireless communication link between the platform server and a user mobile communication device that is associated with the user account, the first wireless communication link conveying account holder information including user account information and information relating to purchase transaction payments to the provider accounts for product or service purchases by the user;
a second communication link between the platform server and a merchant communication device that is associated with the merchant account, the second communication link conveying information relating to business community member transaction credits payments available to the user account for product or service purchases from the merchant by the user;
third communication links between the platform server and provider communication devices that are associated with the provider accounts, the third communication links conveying account holder information including provider account information and information relating to purchase transaction payments to the provider accounts for products or services purchased from the providers by the user; and
a backend transaction processing system operatively associated with the platform server to:
consolidate, as user debits, the purchase transaction payments and consolidate, as user credits, the business community member transaction credits payments accumulated over a first transaction period and attributed to the user account, and to apply to the user account a final user debit amount representing the consolidation of the user debits and user credits attributed to the user account;
consolidate, as merchant debits, the business community member transaction credits payments accumulated for the user account over a second transaction period and attributed to the merchant account, and to apply to the merchant account a final merchant debit amount representing the consolidation of merchant debits attributed to the merchant account; and
to consolidate, as provider credits, the purchase transaction payments, less the business community member transaction credits payments, and the business community member transaction credits payments accumulated for the user account over a third transaction period and attributed to each of the provider accounts, and to apply to each of the provider accounts a final provider credit amount representing the consolidation of the provider credits attributed to the provider account.

2. The system of claim 1, in which the user mobile communication device of the user receives notification of availability of a business community member transaction credit payment by the merchant account, and further comprising a validation beacon device that is associated with the merchant account and is configured to present a credit code, the credit code suitable for scanning by the user mobile communication device to produce a validation signal, the validation signal indicating confirmation of the business community member transaction credit payment for conveyance through the first wireless communication link to the platform server for user credit of the business community member transaction credit payment to the user account.

3. The system of claim 2, in which the notification of availability of a business community member transaction credit payment is conveyed through the first wireless communication link.

4. The system of claim 2, in which the credit code is a member of a set of credit codes of available business community member transaction credits payments, and in which the validation beacon device includes memory stores for the set of credit codes and a display screen for presenting images of the credit codes for scanning by the user mobile communication device.

5. The system of claim 2, in which the credit code is a member of a set of credit codes of available business community member transaction credits payments, and in which the validation beacon device includes a communication signal interface configured to establish short-range wireless communication connectivity with the user mobile communication device, the set of credit codes being operatively connected to the validation beacon device for scanning by the user mobile communication device, and producing the validation signal upon receipt of a member of the set of credit codes scanned by the user mobile communication device during connectivity between the validation beacon device and the user mobile communication device.

6. The system of claim 5, in which the set of credit codes operatively connected to the validation beacon device comprises a number of substrates on each of which a credit code pattern is printed.

7. The system of claim 6, in which the number of substrates are attached to the validation beacon device.

8. The system of claim 6, in which the number of substrates are physically separate from the validation beacon device.

9. The system of claim 5, in which the validation beacon device further includes memory stores for the set of credit codes operatively connected to the validation beacon device and a display screen for presenting images of the credit codes for scanning by the user mobile communication device.

10. The system of claim 1, in which the second communication link conveys business community member transaction credits payments made to the user account for purchases of products or services from the merchant by the user.

11. The system of claim 1, in which the user account is a member of a set of user accounts, mobile communication devices are associated with the user accounts, the first wireless communication link is a member of a set of first wireless communication links conveying account holder information including user account information and information relating to purchase transaction payments to the provider accounts for product or service purchases by the users, and the backend transaction processing system is operatively associated with the platform server to:
consolidate, as a provider credit, for each provider account, the purchase transaction payments, less the business community member transaction credits payments, and the business community member transaction credits payments accumulated for the user accounts over the third transaction period and attributed to the provider account; and
to apply, to each of the provider accounts, a final provider credit amount for each user account, the final provider credit amount representing the consolidation of the provider credits attributed to the user account.

12. A method of reducing transaction payment processing costs by implementing in a transaction processing system a virtual exchange platform that processes debit and credit transactions among multiple subscriber account holder entities, the account holder entities including a user, a provider, and a merchant holding, respectively, a user account, a provider account, and a merchant account, each of the provider and merchant providing a product or service available for purchase by the user, and the provider account and the merchant account set up in the system to conduct financial transactions with the user account, the method comprising:
collecting and storing in the transaction processing system information relating to purchase transaction payments attributed to each one of multiple user accounts and directed to corresponding ones of multiple provider accounts;
collecting in the transaction processing system information relating to business community member transaction credits payments attributed to each one of multiple merchant accounts and the multiple provider accounts, and redeemed by corresponding ones of the user accounts making purchase transaction payments directed to the provider accounts;
consolidating, as user debits, for each user account, the purchase transaction payments directed to the corresponding ones of the multiple provider accounts;
consolidating, as user credits, for each user account, the business community member transaction credits payments redeemed by the corresponding ones of the user accounts;
applying, to each user account, a final user debit amount representing the user debits less the user credits attributed to the user account;
consolidating, as merchant debits, for each merchant account, the merchant credit offer transaction payments redeemed by the corresponding ones of the user accounts;
applying, to each merchant account, a final merchant debit amount representing the consolidation of the merchant debits attributed to the merchant account;
consolidating, as provider credits, to each provider account, the purchase transaction payments less the business community member transaction credits payments attributed to each of the user accounts, and the business community member transaction credits payments redeemed by each of the corresponding ones of the user accounts; and
applying, to each provider account, a final credit amount representing the consolidation of the provider credits attributed to the provider account over a transaction period, thereby, for each provider account, reducing to one payment a payment processing cost for all purchase transaction payments of each user account, the one payment being lower than a total cost of the purchase transaction payments made separately.

13. The method of claim 12, further comprising allocating among the provider accounts the lower payment processing costs of all the provider accounts.

14. A method of processing transfers of member transaction credits among multiple account holder members of a community of businesses allied in support of one another by exchanges of the member transaction credits among them to stimulate commercial activity within the community of businesses, the member transaction credits characterized in that a member transaction credit held in a seller member's account need not be used exclusively to transact a sale of the seller member's goods or services to a buyer member, the method carried out with use of a virtual exchange platform server of a transaction processing system in which each of the multiple account holder members has a member account and communicates with the platform server over a wireless communication link between the platform server and a mobile communication device on which a virtual exchange App operates, the virtual exchange App presenting on the mobile communication device the identities of the multiple account holder members, and the platform server operating to process debit and credit transactions of member transaction credits among the multiple account holder members that exchanged member transaction credits in connection with products or services provided, the method comprising:
storing, for access by the platform server, information relating to values of member transaction credits attributed to each one of the member accounts;
collecting, for use in operation of the platform server, information relating to member transaction credits attributed to each one of the member accounts as exchanges resulting from selling of goods or services and redeemed by corresponding ones of the member accounts as exchanges resulting from buying of goods or services, and the redemption of member transaction credits resulting from a payment command generated in response to assertion of a control actuator produced by the virtual exchange App operating on a mobile communication device associated with a buyer member of the account holder members and recognition of the payment command received by the virtual exchange App operating on a mobile communication device associated with a seller member of the account holder members to complete a transfer of member transaction credits by redemption of the member transaction credits to the member account of the buyer member and credit of the member transaction credits to the member account of the seller member;
consolidating, as community member debits, for each member account, the member transaction credits redeemed by buying of goods or services from the corresponding ones of the member accounts;
consolidating, as community member credits, for each member account, the member transaction credits received by selling of goods or services to the corresponding ones of the member accounts;
applying, to each member account, a final account member holder debit amount representing the consolidation of member transaction credits redeemed by the member account; and
applying, to each member account, a final account member holder credit amount representing the consolidation of member transaction credits credited to the member account, thereby to make a record of available member transaction credits to each account holder member for use in stimulating commercial activity by supporting sale of goods and services offered by the multiple account holder members of the community of businesses.

15. The method of claim 14, in which, in response to the generation of a payment command, a coded pattern is produced for display on the mobile communication device associated with the buyer member and, in response to the receipt of the payment command, the mobile communication device associated with the seller member recognizes the coded pattern displayed.

16. The method of claim 15, in which the coded pattern is a QR code or a barcode.

17. The method of claim 15, in which the platform server causes transmission to the mobile communication device associated with the seller member an electronic message confirming transfer to the seller member's account the member transaction credits redeemed by the buyer member.

18. The method of claim 14, in which, in response to the generation of a payment command, a coded pattern is produced for display on the mobile communication device associated with the seller member, and in which the mobile communication device associated with the buyer member recognizes the coded pattern displayed in response to presentation of the coded pattern.

19. The method of claim 18, in which the coded pattern is a QR code or a barcode.

20. The method of claim 18, in which the platform server causes transmission to the mobile communication device associated with the seller member an electronic message confirming transfer to the seller member's account the member transaction credits redeemed by the buyer member.

21. The method of claim 14, in response to the generation of a payment command, the platform server causes transfer of the member transaction credits redeemed from the member account of the buyer member to the member account of a seller member selected by the buyer member through the App operating on the mobile communication device associated with the buyer member.

22. The method of claim 21, in which the platform server causes transmission to the mobile communication device associated with the seller member an electronic message confirming transfer to the seller member's account the member transaction credits redeemed by the buyer member.

23. The method of claim 14, in which the member transaction credits include business community points.

24. The method of claim 14, in which the member transaction credits include monetary units.
